(19) United States
(12) Patent Application Publication
(10) Pub. No.: US 2023/0212722 A1
(43) Pub. Date: Jul. 6, 2023

(54) ALLOY PARTICLES

(71) Applicants: Murata Manufacturing Co., Ltd., Kyoto-fu (JP); Tohoku Magnet Institute Co., Ltd., Miyagi (JP)

(72) Inventors: Kazuhiro HENMI, Nagaokakyo-shi (JP); Tatsuya TOMITA, Natori-shi (JP); Akira OKUMURA, Nagaokakyo-shi (JP); Katsutoshi UJI, Nagaokakyo-shi (JP); Toru TAKAHASHI, Nagaokakyo-shi (JP)

(73) Assignees: Murata Manufacturing Co., Ltd., Kyoto-fu (JP); Tohoku Magnet Institute Co., Ltd., Miyagi (JP)

(21) Appl. No.: 17/822,551

(22) Filed: Aug. 26, 2022

(30) Foreign Application Priority Data
Aug. 26, 2021 (JP) 2021-138035

(51) Int. Cl. C22C 38/56; C22C 38/02; C22C 38/54; C22C 38/52; C22C 45/02; H01F 1/153; H01F 1/20; H01F 3/08; H01F 5/00; B22F 1/05

(52) U.S. Cl. CPC C22C 38/56; C22C 38/02; C22C 38/54; C22C 38/52; C22C 45/02; H01F 1/153; H01F 1/20; H01F 3/08; H01F 5/00; B22F 1/05; B22F 2301/35; B22F 2304/10

(57) ABSTRACT

An alloy particle contains: total content of Fe and Co: from 82.2 to 96.5 parts by mass; Co: 0 to 30.0 parts by mass; P: 0 to 4.5 parts by mass; B: more than 0 to 5.0 parts by mass; C: 0 to 3.0 parts by mass; Si: 0 to 6.7 parts by mass; Ni: more than 0 to 12.0 parts by mass; Cr: more than 0 to 4.2 parts by mass; total content of Mo, W, Zr, and Nb: 0 to 4.2 parts by mass; total content of P and Cr: 7.4 parts by mass or less; multiplication product of the parts by mass of Ni and Cr: 0.5 or more; and total content of Fe, Co, and Ni: 97.0 parts by mass or less. The alloy particle contains an amorphous phase, and a volume percentage of the amorphous phase is 70% or higher.

### CROSS-REFERENCE TO RELATED APPLICATION

This application claims benefit of priority to Japanese Patent Application No. 2021-138035, filed Aug. 26, 2021, the entire content of which is incorporated herein by reference.

### BACKGROUND

### Technical Field

The present disclosure relates to alloy particles. More specifically, the present disclosure relates to soft magnetic alloy particles having a high saturation magnetic flux density and an excellent corrosion resistance.

### Background Art

Miniaturization of coil components (hereinafter also referred to as “the components”) such as inductors and reactors has been in increasing demand. These components include coils and magnetic cores, and allow conversions between current and magnetic flux. Miniaturization requires, for example, reductions in the number of coil turns and the radius, but such reductions reduce the inductance of the components (i.e., reduces the number of magnetic flux lines). Such a reduction in the inductance can be compensated by increasing the current frequency (switching frequency). Thus, the components are required to be operable at high frequencies.

Small components usually include magnetic cores containing a highly magnetically permeable, soft magnetic material for dramatically increasing the inductance. Such a magnetic core is subject to energy loss (iron loss) associated with magnetic field changes, and the energy loss increases along with an increase in the frequency. In particular, magnetic field changes in the magnetic core at high frequencies generate a large eddy current in the magnetic core due to magnetic induction. As a result, at high frequencies, Joule heating from eddy currents (eddy current loss) has a greater impact on the entire energy loss, interfering with the operation of the components at high frequencies. One solution to reduce the eddy current loss may be a reduction in the dimensions of the soft magnetic material. Thus, powder (sometimes also referred to as a powdered body or alloy particles) is commonly used as a soft magnetic material for a magnetic core at high frequencies.

In addition, use of a material having a high volume resistivity for the magnetic core can reduce the eddy current loss. Between an amorphous phase and a crystalline phase of the same chemical composition, the amorphous phase has a higher volume resistivity than the crystalline phase, so that a material containing an amorphous phase is preferred at high frequencies.

JP 2005-307291 A discloses a technique that uses a powder containing such an amorphous phase for the components. This technique improves the magnetic characteristics by increasing the magnetic permeability of the powder.

### SUMMARY

However, the powder has a large specific surface area, and the amorphous phase of the metal is susceptible to oxidation. Thus, a powder containing an amorphous phase tends to have a lower corrosion resistance. In particular, a reduction in the particle size of a powder for use at high frequencies leads to a significant reduction in the corrosion resistance of the powder.

JP 2005-307291 A discloses a powder containing Si as an element for increasing the corrosion resistance and including a high Si content layer on a surface. JP 2005-307291 A also discloses optional elements, such as Cr, Mo, W, V, Nb, Ta, Ti, Zr, Hf, Pt, Pd, and Au, that increase the corrosion resistance of the powder. Yet, the powder containing these optional elements failed to exhibit sufficient corrosion resistance in a moist atmosphere. As described above, simply adding the elements that increase the corrosion resistance to the powder does not much increase the corrosion resistance required by the powder, depending on the chemical composition. Yet, this issue has been unknown.

Nowadays, components operable at high currents are required. While a greater magnetic field can be generated by passing a higher alternating current through a coil, a component made of a material having a low saturation magnetic flux density may not be operable due to magnetic saturation. However, a powder having a high amorphous phase content that increases the volume resistivity or containing a large amount of elements that increase the corrosion resistance has a low saturation magnetic flux density.

Thus, the conventional technology failed to provide a powder having a high saturation magnetic flux density and an excellent corrosion resistance.

The present disclosure was made in view of the above issue, and provides an alloy particle having a high saturation magnetic flux density and an excellent corrosion resistance. The present disclosure also provides a coil component containing the alloy particle.

An alloy particle according to a first embodiment of the present disclosure contains Fe, B, Ni, and Cr, and optionally Mo, W, Zr, Nb, Co, P, C, and Si. When a total content of Fe, Co, B, Ni, P, C, Si, Nb, Cr, Mo, W, and Zr is taken as 100 parts by mass, the following holds true: total content of Fe and Co: 82.2 parts by mass or more and 96.5 parts by mass or less (i.e., from 82.2 parts by mass to 96.5 parts by mass); Co: 0 parts by mass or more and 30.0 parts by mass or less (i.e., from 0 parts by mass to 30.0 parts by mass); P: 0 parts by mass or more and 4.5 parts by mass or less (i.e., from 0 parts by mass to 4.5 parts by mass); B: more than 0 parts by mass and 5.0 parts by mass or less (i.e., from more than 0 parts by mass to 5.0 parts by mass); C: 0 parts by mass or more and 3.0 parts by mass or less (i.e., from 0 parts by mass to 3.0 parts by mass); Si: 0 parts by mass or more and 6.7 parts by mass or less (i.e., from 0 parts by mass to 6.7 parts by mass); Ni: more than 0 parts by mass and 12.0 parts by mass or less (i.e., from more than 0 parts by mass to 12.0 parts by mass); Cr: more than 0 parts by mass and 4.2 parts by mass or less (i.e., from more than 0 parts by mass to 4.2 parts by mass); total content of Mo, W, Zr, and Nb: 0 parts by mass or more and 4.2 parts by mass or less (i.e., from 0 parts by mass to 4.2 parts by mass); total content of P and Cr: 7.4 parts by mass or less; multiplication product of the parts by mass of Ni and Cr: 0.5 or more; total content of Fe, Co, and Ni: 97.0 parts by mass or less; when the Ni content is more than 0 parts by mass and 7.4 parts by mass or less (i.e., from more than 0 parts by mass to 7.4 parts by mass), a total content of Fe, Co, and Ni is 89.6 parts by mass or more; and when the Ni content is more than 7.4 parts by mass and 12.0 parts by mass or less (i.e., from more than 7.4 parts by mass to 12.0 parts by mass), a difference obtained by subtracting a multiplication product of the parts by mass of Ni×0.5 from the total content of Fe and Co is 78.5 parts by mass or more. The alloy particle contains an amorphous phase, and a volume percentage of the amorphous phase is 70% or higher.

An alloy particle according to a second embodiment of the present disclosure is an alloy particle containing an amorphous phase. The alloy particle contains Fe, B, Ni, and Cr, and optionally Mo, W, Zr, Nb, Co, P, C, and Si. In a depth concentration profile of components of the alloy particle, an inequality N1>N2 is satisfied, where N1 is a Ni concentration at a depth of 0 nm from a surface, and N2 is an average Ni concentration in a region from a depth of 10 nm to 100 nm from the surface, and an average distance D where the Ni concentration is (N1+N2)×0.5 as measured from the surface is 1.3 nm or more.

The alloy particle according to the second embodiment of the present disclosure may include the features of the alloy particle according to the first embodiment of the present disclosure.

A coil component of the present disclosure includes a magnetic core containing the alloy particle of the present disclosure and a coil.

The present disclosure can provide an alloy particle having a high saturation magnetic flux density and an excellent corrosion resistance. Thus, the present disclosure can stably and flexibly provide a small coil component operable at high frequencies and high currents, making it possible to reduce the dimensions of electronic devices usable at high currents.

### BRIEF DESCRIPTION OF DRAWINGS

FIG. 1 is a perspective view schematically showing an example of an inductor as an embodiment of a coil component of the present disclosure;

FIG. 2 is a perspective view showing the structure inside the inductor shown in FIG. 1;

FIG. 3 shows the results of Auger electron spectroscopy (AES) performed on alloy particles of Example 5; and

FIG. 4 shows the results of AES performed on an alloy thin strip of Comparative Example 31.

### DETAILED DESCRIPTION

The present inventors discovered that a combination of Ni and Cr can significantly increase the corrosion resistance of a powder. The present inventors also discovered that Ni concentrated near the surface of the powder in a depth concentration profile by Auger electron spectroscopy can significantly increase the corrosion resistance of the powder. Based on these findings, the present inventors found that a powder having high corrosion resistance can be obtained without changing the amount of ferromagnetic elements and that a powder having high saturation magnetic flux density can be obtained without changing corrosion resistance. The present disclosure was thus completed.

The following describes an alloy particle according to a first embodiment as an embodiment of the present disclosure. Herein, the alloy particle is sometimes referred to as “powder”.

First, a chemical composition of the alloy particle according to the present embodiment is described. The alloy particle according to the present embodiment contains Fe, B, Ni, and Cr, and optionally Mo, W, Zr, Nb, Co, P, C, and Si. The following description holds true provided that the alloy particle contains the elements described above.

In the following description, the term “part(s) by mass” means part(s) by mass when the total content of Fe, Co, B, Ni, P, C, Si, Nb, Cr, Mo, W, and Zr is taken as 100 parts by mass, unless otherwise stated. Likewise, the term “part(s) by mole” means part(s) by mole when the total content of Fe, Co, B, Ni, P, C, Si, Nb, Cr, Mo, W, and Zr is taken as 100 parts by mole, unless otherwise stated.

Total Content of Fe and Co: 82.2 Parts by Mass or More and 96.5 Parts by Mass or Less (i.e., from 82.2 Parts by Mass to 96.5 Parts by Mass)

Co: 0 Parts by Mass or More and 30.0 Parts by Mass or Less (i.e., from 0 Parts by Mass to 30.0 Parts by Mass)

Fe (iron) and Co (cobalt) are ferromagnetic and increase the saturation magnetic flux density. Thus, the total content of Fe and Co is required to be 82.2 parts by mass or more for providing a sufficient saturation magnetic flux density. The total content of Fe and Co is preferably 82.5 parts by mass or more, more preferably 84.9 parts by mass or more for providing a higher saturation magnetic flux density. At the same time, the total content of Fe and Co is required to be 96.5 parts by mass or less for providing sufficient thermal stability of the amorphous phase. The total content of Fe and Co is preferably 92.5 parts by mass or less, more preferably 91.5 parts by mass or less for providing a higher thermal stability of the amorphous phase. In particular, Fe is an element essential for providing a high saturation magnetic flux density without increasing the cost. Thus, the Fe content is required to be 52.2 parts by mass or more. Since Co is expensive, its content may be 0 parts by mass. In other words, the alloy particle may not contain Co. Co by itself has a lower saturation magnetic flux density than Fe, but significantly increases the saturation magnetic flux density by interaction with Fe. Thus, the Co content is preferably 1.0 part by mass or more, more preferably 2.0 parts by mass or more for increasing the saturation magnetic flux density. At the same time, the higher the Co content, the smaller the increment of the saturation magnetic flux density per Co content. Thus, the Co content is required to be 30.0 parts by mass or less. In particular, the Co content is preferably 12.0 parts by mass or less, more preferably 10.0 parts by mass or less.

P: 0 Parts by Mass or More and 4.5 Parts by Mass or Less (i.e., from 0 Parts by Mass to 4.5 Parts by Mass)

P (phosphorus) increases the thermal stability of the amorphous phase. The lower limit of the P content is 0 parts by mass. In other words, the alloy particle may not contain P. The P content is preferably 0.3 parts by mass or more, more preferably 0.6 parts by mass or more for sufficiently increasing the thermal stability of the amorphous phase. At the same time, the P content is required to be 4.5 parts by mass or less for providing a sufficient saturation magnetic flux density. The P content is preferably 3.0 parts by mass or less, more preferably 1.4 parts by mass or less for providing a higher saturation magnetic flux density. The P content may be 0.1 parts by mass or more.

B: More than 0 Parts by Mass and 5.0 Parts by Mass or Less (i.e., from More than 0 Parts by Mass to 5.0 Parts by Mass)

B (boron) is an element essential for increasing the thermal stability of the amorphous phase. The B content is preferably 1.0 part by mass or more, more preferably 1.2 parts by mass or more for providing a higher thermal stability of the amorphous phase. At the same time, the B content is required to be 5.0 parts by mass or less for providing a sufficient saturation magnetic flux density. The B content is preferably 4.0 parts by mass or less for providing a higher saturation magnetic flux density. The B content may be 0.1 parts by mass or more.

C: 0 Parts by Mass or More and 3.0 Parts by Mass or Less (i.e. from 0 Parts by Mass to 3.0 Parts by Mass)

C (carbon) increases the thermal stability of the amorphous phase. The lower limit of the C content is 0 parts by mass. In other words, the alloy particle may not contain C. The total content of B and C is preferably 1.0 part by mass or more for sufficiently increasing the thermal stability of the amorphous phase. The C content is preferably 1.0 part by mass or more, and the total content of B and C is more preferably 2.0 parts by mass or more for providing a higher thermal stability of the amorphous phase. At the same time, the C content is required to be 3.0 parts by mass or less for providing a sufficient saturation magnetic flux density. Too high a C content results in easy formation of Fe₃C phase. Thus, the C content is required to be 3.0 parts by mass or less for providing thermal stability of the amorphous phase. The C content is preferably 2.5 parts by mass or less, more preferably 2.0 parts by mass or less for providing a higher saturation magnetic flux density. The total content of B and C is preferably 8.0 parts by mass or less, more preferably 7.0 parts by mass or less, still more preferably 4.2 parts by mass or less. The C content may be 0.1 parts by mass or more.

Si: 0 Parts by Mass or More and 6.7 Parts by Mass or Less (i.e., from 0 Parts by Mass to 6.7 Parts by Mass)

Si (silicon) increases the thermal stability of the amorphous phase. The lower limit of the Si content is 0 parts by mass. In other words, the alloy particle may not contain Si. The Si content is preferably 0.5 parts by mass or more, more preferably 1.0 part by mass or more for providing a higher thermal stability of the amorphous phase. At the same time, the Si content is required to be 6.7 parts by mass or less for providing a sufficient saturation magnetic flux density. The Si content is preferably 4.0 parts by mass or less for providing a higher saturation magnetic flux density. The Si content may be 0.1 parts by mass or more.

Ni: More than 0 Parts by Mass and 12.0 Parts by Mass or Less (i.e. from More than 0 Parts by Mass to 12.0 Parts by Mass)

Total Content of Fe, Co, and Ni: 97.0 Parts by Mass or Less

When the Ni content is more than 0 parts by mass and 7.4 parts by mass or less (i.e., from more than 0 parts by mass to 7.4 parts by mass), the total content of Fe, Co, and Ni is 89.6 parts by mass or more.

When the Ni content is more than 7.4 parts by mass and 12.0 parts by mass or less (i.e., from more than 7.4 parts by mass to 12.0 parts by mass), the difference obtained by subtracting a multiplication product of the parts by mass of Ni×0.5 from the total content of Fe and Co is 78.5 parts by mass or more.

Ni (nickel) is an element essential for increasing the corrosion resistance. Ni, when added to a chemical composition containing B, exhibits remarkable corrosion resistance. The Ni content is preferably 2.0 parts by mass or more, more preferably 3.6 parts by mass or more for providing a higher corrosion resistance. The Ni content may be 0.1 parts by mass or more.

Too high a Ni content results in a low saturation magnetic flux density and a low Curie temperature, and still too high a Ni content results in a low amorphous forming ability. Thus, the Ni content is required to be 12.0 parts by mass or less. The total content of Fe, Co, and Ni is required to be 97.0 parts by mass or less for sufficiently increasing the thermal stability of the amorphous phase. The Ni content is preferably 10.0 parts by mass or less, more preferably 9.0 parts by mass or less for providing a higher saturation magnetic flux density. In particular, when the Ni content is more than 7.4 parts by mass and 12.0 parts by mass or less (i.e., from more than 7.4 parts by mass to 12.0 parts by mass), the difference obtained by subtracting a multiplication product of the parts by mass of Ni×0.5 from the total content of Fe and Co is required to be 78.5 parts by mass or more for providing a high magnetic flux density. When the Ni content is more than 0 parts by mass and 7.4 parts by mass or less (i.e., from more than 0 parts by mass to 7.4 parts by mass), the total content of Fe, Co, and Ni is required to be 89.6 parts by mass or more.

Cr: More than 0 Parts by Mass and 4.2 Parts by Mass or Less (i.e., from More than 0 Parts by Mass to 4.2 Parts by Mass)

Total Content of P and Cr: 7.4 Parts by Mass or Less

Multiplication Product of Parts by Mass of Ni and Cr: 0.5 or More

Cr (chromium) when combined with P significantly increases the corrosion resistance. Thus, Cr is essential. Further, the presence of Cr causes concentration of Ni near the alloy particle surface, thus providing a higher corrosion resistance. Thus, the multiplication product of the parts by mass of Cr and Ni is required to be 0.5 or more. At the same time, the Cr content is required to be 4.2 parts by mass or less for providing a sufficient saturation magnetic flux density. The Cr content is preferably 3.5 parts by mass or less, more preferably 2.5 parts by mass or less for providing a higher saturation magnetic flux density. The total content of P and Cr is required to be 7.4 parts by mass or less for providing a sufficient saturation magnetic flux density.

Total Content of Mo, W, Zr, and Nb: 0 Parts by Mass or More and 4.2 Parts by Mass or Less (i.e., from 0 Parts by Mass to 4.2 Parts by Mass)

Mo, W, Zr, and Nb are optional elements for increasing the corrosion resistance. At the same time, too high a total content of Mo, W, Zr, and Nb results in a low saturation magnetic flux density. Thus, the total content of Mo, W, Zr, and Nb is required to be 4.2 parts by mass or less. The total content of Mo, W, Zr, and Nb is preferably 2.0 parts by mass or less for providing a higher saturation magnetic flux density.

The alloy particle according to the present embodiment may contain, as impurities, elements other than Fe, Co, B, P, C, Si, Ni, Cr, Mo, W, Zr, and Nb. The impurity content is preferably 1.0 part by mass or less, more preferably 0.50 parts by mass or less for increasing the saturation magnetic flux density. Further, the impurity content is preferably 1.0 part by mole or less, more preferably 0.50 parts by mole or less. Examples of the impurities include N, 0, Al, S, Ca, Ti, V, Cu, Mn, Zn, As, Ag, Sn, Sb, Hf, Ta, Bi, and rare earth elements (REM). The REM includes Sc, Y, La, Ce, Pr, Nd, Pm, Sm, Eu, Gd, Tb, Dy, Ho, Er, Tm, Yb, and Lu. In particular, the content of each of Ca, Ti, and Al is preferably 0.1 parts by mass or less for reducing the hysteresis loss and increasing the thermal stability of the amorphous phase. Likewise, the Cu content is preferably 0.04 parts by mass or less or 0.04 parts by mole or less, more preferably 0.02 parts by mass or less or 0.02 parts by mole or less for increasing the thermal stability of the amorphous phase. The O content is preferably 0.1 parts by mass or less, more preferably 0.05 parts by mass or less for increasing the saturation magnetic flux density. The impurity content may be 0 parts by mass. In other words, the alloy particle may not contain impurities.

The content of each element is measured using a method that allows measurement to a precision of the above significant digits. Specifically, a measurement method described in Examples (described later) and its equivalent measurement method are applied.

Next, an internal structure of the alloy particle according to the present embodiment is described.

The amorphous phase increases the volume resistivity and magnetic permeability of the alloy particle and reduces the magnetic anisotropy and coercive force. Thus, the alloy particle requires the presence of an amorphous phase therein. The average volume percentage of the amorphous phase is required to be 70% or higher, preferably 80% or higher. The average volume percentage of the amorphous phase may be 100%. In other words, the internal structure of the alloy particle is a structure consisting of one or more amorphous phases or a multi-phase structure consisting of an amorphous phase and a crystalline phase. When the alloy particle contains a crystalline phase, the average crystal grain size of each crystalline phase obtained by Scherrer's equation is preferably 30 nm or less, more preferably 25 nm or less for reducing the coercive force. In addition, the crystalline phase is classified into an alloy phase and a compound phase. The alloy phase is, for example, Fe phase or Fe—Si phase having a body-centered cubic structure, and the average volume percentage of the alloy phase may be 10% or higher for increasing the saturation magnetic flux density. The average volume percentage of the compound phase is preferably 10% or lower, more preferably 2% or lower, particularly preferably 1% or lower for reducing the coercive force. The average volume percentage of the compound phase may be 0%. Examples of the compound phases include phases of compounds such as Fe₃P, Fe₃B, Fe₃C, Fe₂B, and oxides and phases of solid solutions of these compounds. The volume percentage of each phase is determined by peak analysis of data obtained by X-ray diffraction (XRD). The peak analysis uses a method described in Examples (described later). Here, the alloy particle is used directly without being pulverized or the like as a sample for XRD. The presence of an amorphous phase in the alloy particle is defined as allowing the amorphous phase content to be calculated by a method described in Examples (described later).

The following describes an alloy particle according to a second embodiment of another embodiment of the present disclosure.

A surface structure of the alloy particle according to the present embodiment is described.

Ni concentrated near the surface of the powder in a depth concentration profile by Auger electron spectroscopy can significantly increase the corrosion resistance of the powder. Specifically, an inequality N1>N2 is satisfied in a depth concentration profile of components of the alloy particle, which is obtained by Auger electron spectroscopy through repetition of surface analysis of the alloy particle and surface layer removal by argon ion irradiation in the stated order. Here, N1 is a Ni concentration at a depth of 0 nm from the surface, and N2 is an average Ni concentration in a region from a depth of 10 nm to 100 nm from the surface. In the alloy particle, an average distance D where the Ni concentration is (N1+N2)×0.5 as measured from the surface is required to be 1.3 nm or more. At the same time, the distance D is 6.0 nm or less, for example.

The concentration profile is obtained by measuring the content (parts by mass) of each component when the total content of Fe, Co, Ni, P, B, C, Si, Nb, Cr, Mo, W, Zr and O is taken as 100 parts by mass.

The depth concentration profile of components of the alloy particle is expressed by a linear equation (straight line) connecting concentration data adjacent to each other in the depth direction as measured, for example, at 1.1-nm intervals in a depth range of 0 nm (inclusive) to less than 11 nm and at 2.2-nm intervals in a depth range of 11 nm to 100 nm.

In measurement using Auger electron spectroscopy (AES), values measured at a depth of 0 nm vary greatly in obtaining optical spectra. Thus, preferably, the measurement at a depth of 0 nm is performed twice to obtain an average. The number of measurement may be increased to obtain an average for further improving the SN ratio.

When the alloy particle has a surface structure having the features described above, one or more elements in the group consisting of Ni and Cr form a fine passivation film, significantly improving the corrosion resistance.

Here, 10 alloy particles are measured by Auger electron spectroscopy, and an average concentration profile of these 10 alloy particles is used.

An internal structure of the alloy particle according to the present embodiment is described.

The alloy particle also contains an amorphous phase in the present embodiment as in the first embodiment.

The second embodiment may include the features of the first embodiment as one modified example of the second embodiment.

Further, more preferred embodiments of the first embodiment, the second embodiment, and the modified example of the second embodiment are described.

The size and shape of the alloy particle according to the present embodiment are described.

The alloy particle may have any size. D50 of the alloy particle size is preferably 1 μm or more and 50 μm or less (i.e., from 1 μm to 50 μm), more preferably 20 μm or more and 40 μm or less (i.e., from 20 μm to 40 μm) for increasing the energy efficiency and the effective magnetic permeability of the magnetic core in the frequency band applicable to the coil component. In particular, when the emphasis is on the energy efficiency at high frequencies and when the emphasis is on the alloy particle filling rate, D50 of the alloy particle size is preferably 1 μm or more and 10 μm or less (i.e., from 1 μm to 10 μm), more preferably 1 μm or more and 6 μm or less (i.e., from 1 μm to 6 μm). D90 of the alloy particle size is preferably 100 μm or less, more preferably 80 μm or less, particularly preferably 60 μm or less for facilitating formation of the magnetic core or ensuring insulation of the coil component. D90 of the alloy particle size may be 1 μm or more. Here, D50 and D90 mean the particle sizes at cumulative frequencies of 50% and 90%, respectively, from the smallest particle size in the volume particle size distribution.

Likewise, the alloy particle may have any shape. For example, the aspect ratio may be 0.10 or more and 0.70 or less (i.e., from 0.10 to 0.70) for active use of shape magnetic anisotropy. Meanwhile, the aspect ratio may be 0.70 or more and 1.0 or less (i.e., from 0.70 to 1.0) for allowing an increase in the magnetic permeability of the coil component without considering anisotropy. When emphasis is on the alloy particle filling rate, the aspect ratio is preferably 0.70 or more and 0.95 or less (i.e., from 0.70 to 0.95), more preferably 0.75 or more and 0.90 or less (i.e., from 0.75 to 0.90). Here, the aspect ratio is the ratio of the major axis to the minor axis of a two-dimensional projection image of the alloy particle, and is determined by averaging the values from at least 10 alloy particles.

A surface structure and a surface coating of the alloy particle according to the present embodiment are described.

In addition to the passivation film, a coating may be separately formed, if necessary, on the alloy particle surface. The coating may be an oxide or nitride layer for increasing the insulation between the alloy particles. The coating is preferably an oxide layer containing phosphate or Si. The coating may be formed by any method, but is preferably formed by sol-gel or mechanochemical reaction for providing high insulation.

Internal stress of the alloy particle according to the present embodiment is described.

The internal stress of the alloy particle is preferably small for reducing the coercive force, but quantification of the internal stress is difficult. Considering the influence of internal stress on the coercive force, the coercive force of the alloy particle is preferably 500 A/m or less, more preferably 200 A/m or less, still more preferably 100 A/m or less. The coercive force of the alloy particle may be 0.0 A/m or more or 0.1 A/m or more.

The following describes a magnetic core according to an embodiment of the present disclosure.

The magnetic core according to the present embodiment contains the alloy particle according to the above embodiment. For stable bonding, the magnetic core may contain a resin. The resin may be at least one selected from the group consisting of an epoxy resin, a phenolic resin, and a silicone resin. Further, the magnetic core may contain an additional magnetic material different from the alloy particle of the above embodiment, and may contain a non-magnetic material such as an oxide.

The following describes a coil component according to an embodiment of the present disclosure.

The coil component according to the present embodiment contains the magnetic core according to the above embodiment and a coil. The coil may be wound around the magnetic core or may be surrounded by the magnetic core. Examples of the coil component include inductors, reactors, and components including these components (e.g., DC-DC converter).

FIG. 1 is a perspective view schematically showing an example of an inductor as an embodiment of the coil component of the present disclosure.

The inductor shown in FIG. 1 includes a rectangular magnetic core 14, a protective layer 15 at a substantially center on a surface of the magnetic core 14, and a pair of an external electrode 16a at one end of the surface of the magnetic core 14 and an external electrode 16b at the other end thereof sandwiching the protective layer 15 therebetween.

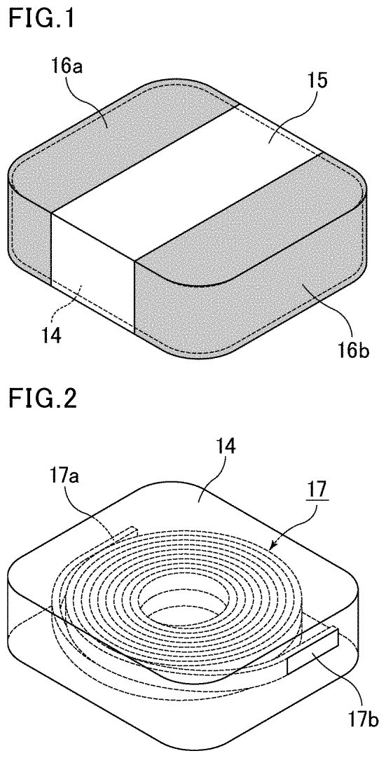

FIG. 2 is a perspective view showing the structure inside the inductor shown in FIG. 1. In FIG. 2, the protective layer 15, the external electrode 16a, and the external electrode 16b are omitted for the sake of description.

The magnetic core 14 is made of a composite material containing, for example, the alloy particle of the present disclosure as a main component and a resin material such as an epoxy resin. A coil 17 is embedded in the magnetic core 14.

The alloy particle content of the composite material is not limited, but is preferably 60% by volume or more based on the volume percentage. When the alloy particle content is less than 60% by volume, the magnetic permeability and the saturation magnetic flux density may be reduced due to an excessively low alloy particle content, possibly resulting in poor magnetic characteristics. The upper limit of the alloy particle content is preferably 99% by volume or less for allowing the resin material to be contained in an amount sufficient to achieve desired effects.

For example, the coil 17 has a cylindrical shape in which a flat wire is wound into a coil. Ends 17a and 17b of the coil 17 are exposed at end surfaces of the magnetic core 14 to be electrically connectable to the external electrodes 16a and 16b, respectively. The coil 17 is obtained, for example, by winding a flat wire conductor made of copper or the like coated with an insulation resin such as an polyester resin or polyamide-imide resin and formed in a band shape into a coil such that the coil has an air core.

The inductor shown in FIG. 1 can be produced by the following method, for example.

First, the alloy particles of the present disclosure are kneaded with a resin material and dispersed to produce a composite material. Next, the coil 17 is embedded in the composite material such that the coil 17 is sealed by the composite material. Then, molding is performed, for example, by the compression molding method, whereby a molding in which the coil 17 is embedded is obtained. The resulting molding is removed from a mold, heated, and surface-polished, whereby the magnetic core 14 in which the ends 17a and 17b of the coil 17 are exposed at the end surfaces of the magnetic core 14 is obtained.

Next, an insulation resin is applied to the surface of the magnetic core 14 excluding the portions where the external electrodes 16a and 16b are to be formed, and the insulation resin is cured to form the protective layer 15.

Subsequently, the external electrodes 16a and 16b containing a conductive material as a main component are formed at the respective ends of the magnetic core 14. The inductor is produced as described above.

The external electrodes 16a and 16b may be formed by any method, and can be formed by, for example, a coating method, a plating method, a thin film forming method, or any other method.

In the inductor shown in FIG. 1, the coil 17 is embedded in the magnetic core 14 that contains the alloy particles described above as a main component, resulting in in high saturation magnetic flux density and low magnetic loss. This enables highly efficient production of a high purity and high quality ferromagnetic coil component having good soft magnetic characteristics with low hysteresis.

In the above embodiment, a coil component such as an inductor is described as an example of a device including the alloy particles of the present disclosure. The alloy particle of the present disclosure, which has a high saturation magnetic flux density and low magnetic loss, is also applicable to a stator core or a rotor core included in a motor. The motor usually includes a stator core including multiple armature teeth equally spaced on the same circumference, a coil wound around the armature teeth, and a rotor core rotatably arranged inside the stator core. As described above, the alloy particle of the present disclosure has a high saturation magnetic flux density and low magnetic loss. Thus, a high quality motor with low power loss is obtainable when at least one of the stator core or the rotor core (preferably both) contains the alloy particles of the present disclosure as a main component.

The following describes an electronic device according to an embodiment of the present disclosure.

The electronic device according to the present embodiment includes the coil component according to the above embodiment. Examples of the electronic device include smartphones, tablets, personal computers, server equipment, and telecommunications equipment. Examples of mobility including the electronic device include electric vehicles, hybrid vehicles, motorcycles, aircraft, and railroads.

The following describes a method of producing an alloy particle according to an embodiment of the present disclosure.

The method of producing an alloy particle according to the present embodiment includes a dissolution step and a solidification step.

In the dissolution step, raw materials are heated and melted to prepare molten metal. The chemical composition of the molten metal can be controlled by selecting and blending multiple raw materials or refining the molten metal such that the molten metal has a predetermined chemical composition. Alternatively, a mother alloy prepared by melting and solidifying in advance or a pulverized product of such a mother alloy may be used for facilitating prediction of the chemical composition. Alternatively, different types of molten metal of different chemical compositions may be mixed to prepare intended molten metal. Examples of the raw materials include pure iron, pig iron, iron scraps, ferroalloys (ferroboron, ferrophosphorus, ferrosilicon, and ferrochrome), graphite, elemental phosphorus, and metallic chromium. In particular, the chemical composition of the molten metal may be the chemical composition described in the first embodiment. The molten metal having such a chemical composition is effective in significantly reducing oxidation of the alloy particle particularly after the alloy particle is atomized with water. The heating method may be indirect resist heating, induction heating, or arc heating.

The temperature of the molten metal is required to be higher than the liquidus temperature for producing an alloy particle having a uniform chemical composition and containing an amorphous phase. At the same time, the temperature of the molten metal is preferably lower than the liquidus temperature plus 500° C. for increasing cooling efficiency in the solidification step and stably forming an amorphous phase.

Preferably, the dissolution step has a duration during which the molten metal is kept at an intended molten metal temperature for homogenizing the chemical composition of the molten metal. For example, the duration is preferably one minute or more, more preferably five minutes or more. At the same time, the duration is preferably 60 minutes or less, more preferably 30 minutes or less for reducing dissipation of high vapor pressure elements and dissolution of atmospheric gases into the molten metal.

The atmosphere in contact with the molten metal may be an air atmosphere. The atmosphere may be an inert gas atmosphere containing nitrogen or argon or an atmosphere with controlled oxygen potential for increasing the alloy particle yield.

In the solidification step, the molten metal is pulverized into a droplet, and the droplet is solidified to produce the alloy particle. The molten metal can be pulverized and solidified by atomization. Examples of the atomization that can be selected include water atomization, gas atomization, disc atomization, atomization using a combustion flame jet, and a combination of these. For example, the molten metal after being pulverized by gas atomization and atomization using a combustion flame jet may be quenched by water atomization. A fluid for atomization may be water, a gas such as an inert gas, or a mist-containing gas. The fluid supply rate is set in a range sufficient for removing heat from the molten metal and allowing formation of an amorphous phase during solidification of the molten metal. The fluid is particularly preferably water with high cooling capacity particularly for stably forming an amorphous phase.

When the solidification step is water atomization, the water pressure is required to be 20 MPa or more and 250 MPa or less (i.e., from 20 MPa to 250 MPa). When the water pressure is lower than 20 MPa, the volume percentage of the amorphous phase of the resulting alloy particle is low, thus increasing the coercive force. A water pressure exceeding 250 MPa results in too small an average alloy particle size, thus reducing the alloy particle filling rate and reducing the inductance of the coil component. In the case of a chemical composition with low amorphous forming ability, the molten metal is preferably pulverized by high water pressure. Thus, the water pressure is preferably 50 MPa or more and 250 MPa or less (i.e., from 50 MPa to 250 MPa). Further, in the case of a chemical composition having low amorphous forming ability, the water pressure is preferably 70 MPa or more and 250 MPa or less (i.e., from 70 MPa to 250 MPa).

The method of producing an alloy particle according to the present embodiment may further include a drying step after the solidification step. Preferably, the drying step immediately follows the solidification step. For example, when water is used in the solidification step, a wetted alloy particle (slurry) may be obtained from a mixture of the water and the alloy particle by a separation method such as cyclone, filtration, or sedimentation for increasing the drying energy efficiency. In the slurry, the alloy particle is in contact with the water and gas, and thus easily corroded when the gas contains oxygen gas. Thus, preferably, the oxygen partial pressure is reduced to 40 Pa or less. Alternatively, inert gas may be introduced into water or a mixture of water and the alloy particle for use in atomization for reducing oxygen dissolved in the water. The mass of water in the slurry is preferably 5 or more and 100 or less (i.e., from 5 to 100), more preferably 20 or more and 80 or less (i.e., from 20 to 80) when the mass of the alloy particle in the slurry is taken as 100, for reducing the area of direct contact between the oxygen gas in the atmosphere and the alloy particle.

The alloy particle can be dried by heating, vacuum, or a combination thereof. When drying by heating, preferably, the oxygen partial pressure is 20 Pa or less, and the temperatures is 100° C. or higher and 250° C. or lower (i.e., from 100° C. to 250° C.), and more preferably, the oxygen partial pressure is 2 Pa or less, and the temperatures is 120° C. or higher and 200° C. or lower (i.e., from 120° C. to 200° C.), for preventing the saturation magnetic flux density from being reduced by an increase in the oxide content. Stirring may be performed during drying for preventing particles aggregation or solidification or attachment of the particle to a dry container. Stress may be applied to the alloy particles after drying for loosening the aggregated or solidified particle or the particles attached to the dry container. The drying step may be performed multiple times. Presumably, a passivation film is formed on the alloy particle surface between the solidification step and the drying step.

The method of producing an alloy particle according to the present embodiment may further include a classification step after the solidification step. The classification step may immediately follow any of the following steps: the solidification step, the drying step, a blending step (described later), a heat treatment step (described later), and a surface treatment step (described later). In classification step, the alloy particle size distribution is adjusted. For example, a vibrating sieve, an ultrasonic sieve, airflow classification, or the like can be used for adjusting the particle size distribution. The classification method may be based on differences in inertial force, weight ratio, and fluidity between the particles. The intended particle size distribution preferably satisfies the preferred ranges of D50 and D90 mentioned in the above embodiment, for example. The classification step may be performed multiple times.

The method of producing an alloy particle according to the present embodiment may further include a blending step after the solidification step. The blending step may immediately follow any of the following steps: the solidification step, the drying step, the classification step, a heat treatment step (described later), and a surface treatment step (described later). In the blending step, one or more powders are mixed. The combination of powders to be mixed is not limited as long as at least one powder is obtained by the method of producing an alloy particle according to the present embodiment. Two or more powders having different chemical compositions, structures, or particle size distributions may be mixed. For example, the alloy particles having a D50 of 50 μm may be mixed with the alloy particles having a D50 of 4 μm. A soft magnetic material, such as Fe—Si crystalline powder, Fe—Si—Cr crystalline powder, Fe—B amorphous powder, Fe—Si—B amorphous powder, Fe—Si—B—P amorphous powder, iron powder, or nano-crystal powder, may be mixed with the alloy particle. A non-magnetic material, such as an inorganic filler, may be mixed with the alloy particle.

The method of producing an alloy particle according to the present embodiment may further include a heat treatment step after the solidification step. The heat treatment step may immediately follow any of the following steps: the solidification step, the drying step, the classification step, the blending step, and a surface treatment step (described later). In the heat treatment step, the alloy particle is heated for reducing the internal stress (internal strain) in the alloy particle. The heat treatment temperature is required to be lower than the crystallization start temperature for ensuring a sufficient amount of amorphous phase of the alloy particle. Preferably, the heat treatment temperature is lower than the crystallization start temperature by 20° C. or more. Preferably, the heat treatment temperature is 300° C. or higher for sufficiently reducing the internal stress. For example, the heat treatment temperature may be 300° C. or higher and 550° C. or lower (i.e., from 300° C. to 550° C.). The temperature increase rate may be 1° C./min or more and 5000° C./min or less (i.e., from 1° C./min to 5000° C./min). The crystallization start temperature changes according to the temperature increase rate, so that the crystallization start temperature corresponding to the temperature increase rate is specified and determined by differential scanning calorimetry (DSC). For a temperature increase rate that cannot be obtained by DSC, the crystallization start temperature is determined by extensively applying the relationship between the temperature increase rate and the crystallization start temperature determined by DSC to a higher temperature increase rate. The duration during which the alloy particle is kept at a temperature of 300° C. or higher is preferably one minute or more for sufficiently reducing the internal stress. The duration is preferably 120 minutes or less for preventing formation of coarse crystal grains. The atmosphere for heat treatment is preferably an inert gas atmosphere with controlled oxygen potential for preventing the saturation magnetic flux density from being reduced by an increase in the oxide content. For example, the oxygen partial pressure in the atmosphere is preferably 100 Pa or less. The heating method may use electromagnetic waves such as infrared or may use induction heating, for example. Alternatively, the alloy particle may be heated by bringing a heated medium (solid, liquid, gas, or a mixture thereof) into contact with or close to the alloy particle.

The method of producing an alloy particle according to the present embodiment may further include a surface treatment step after the solidification step. The surface treatment step may immediately follow any of the following steps: the solidification step, the drying step, the classification step, the blending step, and the heat treatment step. In the surface treatment step, for example, chemical conversion, mechanochemical reaction, sol-gel reaction, or the like can be used. In the surface treatment step, a coating that can be optionally separately formed can be formed on the alloy particle surface.

The alloy particles according to the first embodiment and the second embodiment and the alloy particles according to their preferred embodiments can be suitably produced by the method of producing an alloy particle according to the present embodiment, but may be produced by a production method different from the production method of the present embodiment.

The following describes a method of producing a magnetic core according to an embodiment of the present disclosure.

The method of producing a magnetic core according to an embodiment of the present disclosure uses the alloy particle according to the above embodiment. The magnetic core can be molded, for example, by press molding, molding using a mold, or the like. Specifically, a molding method can be selected from cold uniaxial pressing, hot uniaxial pressing, discharge plasma sintering (SPS), cold hydrostatic pressing, hot hydrostatic pressing, sheet forming, potting forming, transfer forming, injection molding, and the like. Additives such as a binder may be added to the alloy particle according to the above embodiment. The binder may be at least one selected from the group consisting of an epoxy resin, a phenolic resin, and a silicone resin. Examples of other additives may include silane coupling agents, lubricants, curing accelerators, and curing retardants.

### Examples

Examples that more specifically disclose the present disclosure are described below. The present disclosure is not limited to these examples.

### Production of Alloy Particles

Raw materials were weighed such that the alloy particles would have the chemical compositions shown in Tables 1 and 3, taking into account changes in chemical composition caused by slag formation during melting. The total weight of raw materials was 150 g. As the Fe source, MATRON flakes (purity: 99.95 wt %) available from Toho Zinc Co., Ltd. were used. As the B source, C source, Si source, Ni source, Cr source, Mo source, W source, Zr source, Nb source, and Co source, materials available from Kojundo Chemical Lab. Co., Ltd. were used. As the P source and Fe source, massive iron phosphide Fe₃P (purity: 99 wt %) was used. As the B source, granular boron (purity: 99.5 wt %) was used. As the C source, powdered graphite (purity: 99.95 wt %) was used. As the Si source, Ni source, Cr source, Mo source, W source, Zr source, Nb source, and Co source, pure metal (purity: 99 wt % or higher) was used.

The raw materials were placed in an aluminum crucible, and heated to 1400° C. in an argon gas atmosphere at 1.0 atm by high-frequency induction heating. The raw materials were kept at 1400° C. for 10 minutes to prepare molten metal. The molten metal was flowed down from a hole at a lower part of the crucible, and alloy particles were produced from the molten metal by water atomization. The alloy particles were collected into a sedimentation tank. The water pressure in water atomization was 80 MPa.

In Comparative Example 30, the raw material makeup of the chemical composition is the same as that in Example 30, but the water pressure (one of the atomization operating conditions) was set to 0.5 times (40 MPa) that in Example 30.

After atomization, the sedimentation tank was left to stand for 30 minutes to precipitate the alloy particles in sedimentation tank, and the alloy particles in a muddy form were collected. In the muddy alloy particles, the mass of water was 50 relative to the mass of the alloy particles taken as 100. The muddy alloy particles were heated to 200° C. at a pressure of 1 Pa or less, and then kept at 200° C. for 180 minutes to dry the alloy particles. The dried alloy particles were classified by a vibrating sieve, and the alloy particles that passed through a sieve with an opening of 20 μm but not passed through a sieve with an opening of 53 μm were collected.

### Measurement of D50

The average particle size D50 of the alloy particles was measured using a laser diffraction particle size distribution analyzer (HELOS/RODOS available from Sympatec). The dispersion pressure was set to 2 bar (200 kPa).

### (Quantitation of Chemical Composition)

The B content and the C content of the alloy particles were measured by atomic absorption. The contents of elements (Fe, P, Si, Ni, Cr, Mo, W, Zr, Nb, Co) other than B and C were measured by inductively coupled plasma mass spectrometry (ICP-MS).

### Measurement of Volume Ratio Va of Amorphous Phase

Using an X-ray diffractometer Miniflex (Cu tube) available from Rigaku Corporation, the alloy particles were directly measured by the θ-2θ method, and a diffraction intensity profile was obtained. The step size was set to 0.01°, the scan speed was set to 5°/min, and the scan range of 2θ was set to 25° or more and 90° or less (i.e., from 25° to 90°). In the diffraction intensity profile, a halo derived from the amorphous phase, a (110) peak derived from (110) plane of a crystalline phase having a body-centered cubic structure, and a peak of the compound phase may appear near 2θ=44°. The area intensity Ia of the halo, the area intensity Ic of the (110) peak, and the area intensity Ic′ of the peak of the compound phase were calculated from the diffraction intensity profile by the method disclosed in Japanese Patent Application No. 2017-532527, and the volume percentage Va of the amorphous phase was determined by the following formula (1). The volume percentage Vc of the crystalline phase having a body-centered cubic structure can be determined by the following formula (2).

Va=Ia/(Ia+Ic+Ic′) (1)

Vc=Ic/(Ia+Ic+Ic′) (2)

### Determination of Surface Concentration Profile

For one or more examples and one or more comparative examples, changes in the chemical composition in the depth direction from the alloy particle surface to the inside were measured by Auger electron spectroscopy (AES). In this measurement, surface analysis and surface layer removal by argon ion irradiation were repeated in the stated order. The changes were measured at 1.1-nm intervals in a depth range of 0 nm (inclusive) to less than 11 nm and at 2.2-nm intervals in a depth range of 11 nm to 100 nm. The measurement was performed twice at a depth of 0 nm, and an average was determined. The measurement was performed once at the positions other than the depth of 0 nm. A total of 10 alloy particles were measured by AES, and concentration profiles of these 10 alloy particles were averaged for use.

### Measurement of Saturation Magnetic Flux Density Bs

A cylindrical container for powder was filled with the alloy particles and pressurized. The saturation mass magnetization Ms of the alloy particles was measured at a maximum magnetic field of 10 kOe by a vibrating sample magnetometer (VSM-5-15 available from Toei Industry Co., Ltd.).

The apparent density ρ was measured by a pycnometer method (AccuPycII1340 available from Shimadzu Corporation). Helium (He) was used as a replacement gas, and the alloy particles (25 g) were used as samples.

The saturation magnetic flux density Bs was calculated from the following formula (3) using the saturation mass magnetization Ms and the apparent density ρ.

Bs=4π×Ms×ρ (3)

### Measurement of Coercive Force Hc

The alloy particles were packed into a capsule for measuring powder, and the capsule was pressurized to prevent the particles from moving during application of a magnetic field. The coercive force Hc of the alloy particles in the capsule was measured by a coercive force meter “K-HC1000” available from Tohoku Steel Co., Ltd.

Measurement of Corrosion Potential E_{corr} and Corrosion Current Density i_{corr} in Alloy Particles

The corrosion potential (natural potential) E_{corr} and the corrosion current density i_{corr} of the alloy particles were measured by an electrochemical measurement system (HZ-5000 available from Hokuto Denko Corporation). GRC-3155, RE-2, and CE-2 available from EC Frontier Co., Ltd. were used as a working electrode, a reference electrode, and a counter electrode, respectively. The alloy particles and a carbon paste (CPO (model number: 001010) available from BAS Inc.) were mixed at a mass ratio of 2:1, and the resulting mixture was packed into a hole of a cylindrical working electrode. The working electrode was immersed in a 3% by mass NaCl aqueous solution for one hour, and then the natural potential E_{corr} was measured. Subsequently, voltage was applied to the working electrode from natural potential to +300 mV to obtain an anodic polarization curve. The scan speed was set to 2 mV/s, and the sampling interval was set to 2 s. Corrosion current determined from the anodic polarization curve was divided by the cross-sectional area (0.0176 cm²) of the reference electrode to determine the corrosion current density i_{corr}. The corrosion current density i_{corr} was defined as the current density at a potential corresponding to the corrosion potential plus 100 mV. The corrosion potential was used as an indicator for corrosion resistance.

Table 2 and Table 3 show D50, Va, Bs, Hc, E_{corr}, and i_{corr} of the alloy particles.

TABLE 1

| | | | | | | | | | | | | | | | | Difference | | | |
|---|---|---|---|---|---|---|---|---|---|---|---|---|---|---|---|---|---|---|---|
| | | | | | | | | | | | | | | | | obtaned by | | | |
| | | | | | | | | | | | | | | | | subtracting the | | | |
| | | | | | | | | | | | | | | | | multiplication | | | |
| | | | | | | | | | | | | | | | | product of | | | |
| | | | | | | | | | | | | | | | | parts by | | | |
| | | | | | | | | | | | | | | | | mass of | | | |
| | | | | | | | | | | | | | | | | Ni × 0.5 | | | |
| | | | | | | | | | | | | | | | | from the | | | |
| | | | | | | | | | | | | | | | | total | | | |
| | | | | | | | | | | | | | | | | parts by | | | |
| | | | | | | | | | | | | | | | Total | mass of | | | |
| | | | | | | | | | | | | | | | content of | Fe and Co | | | |
| | | | | | | | | | | | | | | | Fe, Co, | (When | | | |
| | | | | | | | | | | | | | | | and Ni | the Ni | | | |
| | | | | | | | | | | | | | Total | Total | When the | content is | | | |
| | | | | | | | | | | | | | content | content | Ni content | higher | Total | Multiplication | |
| | | | | | | | | | | | | | of | of | is 7.4 parts | than 7.4 | content of | product | Total |
| | | | | | | | | | | | | | Fe and | Fe, Co, | by mass or | parts | Mo, W, Zr, | of the | content of |
| | | | | | | | | | | | | | Co | and Ni | less) | by mass) | and Nb | parts by | P and Cr |
| | Chemical composition [parts by mass] | | | | | | | | | | | | [parts by | [parts by | [parts by | [parts by | [parts by | mass of | [parts |
| | Fe | P | B | C | Si | Ni | Cr | Co | Mo | W | Zr | Nb | mass] | mass] | mass] | mass] | mass] | Ni and Cr | by mass] |
| Ex- | 91.5 | 1.0 | 1.1 | 1.4 | 1.0 | 3.0 | 1.0 | 0.0 | 0.0 | 0.0 | 0.0 | 0.0 | 91.5 | 94.5 | 94.5 | — | 0.0 | 3.0 | 2.0 |
| ample 1 | | | | | | | | | | | | | | | | | | | |
| Ex- | 90.2 | 3.0 | 1.1 | 0.7 | 1.0 | 3.0 | 1.0 | 0.0 | 0.0 | 0.0 | 0.0 | 0.0 | 90.2 | 93.2 | 93.2 | — | 0.0 | 3.0 | 4.0 |
| ample 2 | | | | | | | | | | | | | | | | | | | |
| Ex- | 87.9 | 2.0 | 1.1 | 1.0 | 1.0 | 6.0 | 1.0 | 0.0 | 0.0 | 0.0 | 0.0 | 0.0 | 87.9 | 93.9 | 93.9 | — | 0.0 | 6.0 | 3.0 |
| ample 3 | | | | | | | | | | | | | | | | | | | |
| Ex- | 87.9 | 2.0 | 1.1 | 1.0 | 1.0 | 6.0 | 1.0 | 0.0 | 0.0 | 0.0 | 0.0 | 0.0 | 87.9 | 93.9 | 93.9 | — | 0.0 | 6.0 | 3.0 |
| ample 4 | | | | | | | | | | | | | | | | | | | |
| Ex- | 87.9 | 3.0 | 1.1 | 0.7 | 1.0 | 6.0 | 1.0 | 0.0 | 0.0 | 0.0 | 0.0 | 0.0 | 87.9 | 93.2 | 93.2 | — | 0.0 | 6.0 | 4.0 |
| ample 5 | | | | | | | | | | | | | | | | | | | |
| Ex- | 94.2 | 0.3 | 0.9 | 1.3 | 0.3 | 2.0 | 1.0 | 0.0 | 0.0 | 0.0 | 0.0 | 0.0 | 94.2 | 96.2 | 96.2 | — | 0.0 | 2.0 | 1.3 |
| ample 6 | | | | | | | | | | | | | | | | | | | |
| Ex- | 89.8 | 0.3 | 1.5 | 1.0 | 0.5 | 6.5 | 0.4 | 0.0 | 0.0 | 0.0 | 0.0 | 0.0 | 89.8 | 96.3 | 96.3 | — | 0.0 | 2.6 | 0.7 |
| ample 7 | | | | | | | | | | | | | | | | | | | |
| Ex- | 85.0 | 2.0 | 1.3 | 1.0 | 2.4 | 7.5 | 0.8 | 0.0 | 0.0 | 0.0 | 0.0 | 0.0 | 85.0 | 92.5 | — | 81.3 | 0.0 | 6.0 | 2.8 |
| ample 8 | | | | | | | | | | | | | | | | | | | |
| Ex- | 84.0 | 3.0 | 1.0 | 1.1 | 0.6 | 10.0 | 0.3 | 0.0 | 0.0 | 0.0 | 0.0 | 0.0 | 84.0 | 94.0 | — | 79.0 | 0.0 | 3.0 | 3.3 |
| ample 9 | | | | | | | | | | | | | | | | | | | |
| Ex- | 86.8 | 1.0 | 0.9 | 0.9 | 0.7 | 9.5 | 0.2 | 0.0 | 0.0 | 0.0 | 0.0 | 0.0 | 86.8 | 96.3 | — | 82.1 | 0.0 | 1.9 | 1.2 |
| ample 10 | | | | | | | | | | | | | | | | | | | |
| Ex- | 83.5 | 2.5 | 1.9 | 1.2 | 1.4 | 8.0 | 1.5 | 0.0 | 0.0 | 0.0 | 0.0 | 0.0 | 83.5 | 91.5 | — | 79.5 | 0.0 | 12.0 | 4.0 |
| ample 11 | | | | | | | | | | | | | | | | | | | |
| Ex- | 88.0 | 0.5 | 0.7 | 1.2 | 0.6 | 5.0 | 4.0 | 0.0 | 0.0 | 0.0 | 0.0 | 0.0 | 88.0 | 93.0 | 93.0 | — | 0.0 | 20.0 | 4.5 |
| ample 12 | | | | | | | | | | | | | | | | | | | |
| Ex- | 88.2 | 4.5 | 0.9 | 1.2 | 1.8 | 2.9 | 0.5 | 0.0 | 0.0 | 0.0 | 0.0 | 0.0 | 88.2 | 91.1 | 91.1 | — | 0.0 | 1.5 | 5.0 |
| ample 13 | | | | | | | | | | | | | | | | | | | |
| Ex- | 88.5 | 2.5 | 1.8 | 1.0 | 1.7 | 2.5 | 2.0 | 0.0 | 0.0 | 0.0 | 0.0 | 0.0 | 88.5 | 91.0 | 91.0 | — | 0.0 | 5.0 | 4.5 |
| ample 14 | | | | | | | | | | | | | | | | | | | |
| Ex- | 91.0 | 2.0 | 1.5 | 1.0 | 0.0 | 4.0 | 0.5 | 0.0 | 0.0 | 0.0 | 0.0 | 0.0 | 91.0 | 95.0 | 95.0 | — | 0.0 | 2.0 | 2.5 |
| ample 15 | | | | | | | | | | | | | | | | | | | |
| Ex- | 87.0 | 0.8 | 1.0 | 1.2 | 5.0 | 4.0 | 1.0 | 0.0 | 0.0 | 0.0 | 0.0 | 0.0 | 87.0 | 91.0 | 91.0 | — | 0.0 | 4.0 | 1.8 |
| ample 16 | | | | | | | | | | | | | | | | | | | |
| Ex- | 90.0 | 0.2 | 0.8 | 1.0 | 3.0 | 4.0 | 1.0 | 0.0 | 0.0 | 0.0 | 0.0 | 0.0 | 90.0 | 94.0 | 94.0 | — | 0.0 | 4.0 | 1.2 |
| ample 17 | | | | | | | | | | | | | | | | | | | |
| Ex- | 84.0 | 1.2 | 0.8 | 1.0 | 4.0 | 8.0 | 1.0 | 0.0 | 0.0 | 0.0 | 0.0 | 0.0 | 84.0 | 92.0 | — | 80.0 | 0.0 | 8.0 | 2.2 |
| ample 18 | | | | | | | | | | | | | | | | | | | |
| Ex- | 86.5 | 1.0 | 4.0 | 1.0 | 0.0 | 6.3 | 1.2 | 0.0 | 0.0 | 0.0 | 0.0 | 0.0 | 86.5 | 92.8 | 92.8 | — | 0.0 | 1.6 | 2.2 |
| ample 19 | | | | | | | | | | | | | | | | | | | |
| Ex- | 90.8 | 1.0 | 3.0 | 0.0 | 0.5 | 2.7 | 2.0 | 0.0 | 0.0 | 0.0 | 0.0 | 0.0 | 90.8 | 93.5 | 93.5 | — | 0.0 | 5.4 | 3.0 |
| ample 20 | | | | | | | | | | | | | | | | | | | |
| Ex- | 87.6 | 0.3 | 4.5 | 1.9 | 0.0 | 5.0 | 0.7 | 0.0 | 0.0 | 0.0 | 0.0 | 0.0 | 87.6 | 92.6 | 92.6 | — | 0.0 | 3.5 | 1.0 |
| ample 21 | | | | | | | | | | | | | | | | | | | |
| Ex- | 88.0 | 0.4 | 5.0 | 0.0 | 0.9 | 5.0 | 0.7 | 0.0 | 0.0 | 0.0 | 0.0 | 0.0 | 88.0 | 93.0 | 93.0 | — | 0.0 | 3.5 | 1.1 |
| ample 22 | | | | | | | | | | | | | | | | | | | |
| Ex- | 87.9 | 0.3 | 4.3 | 2.5 | 0.0 | 4.0 | 1.0 | 0.0 | 0.0 | 0.0 | 0.0 | 0.0 | 87.9 | 91.9 | 91.9 | — | 0.0 | 4.0 | 1.3 |
| ample 23 | | | | | | | | | | | | | | | | | | | |
| Ex- | 86.9 | 3.2 | 0.8 | 0.9 | 0.0 | 4.0 | 4.2 | 0.0 | 0.0 | 0.0 | 0.0 | 0.0 | 86.9 | 90.9 | 90.9 | — | 0.0 | 16.8 | 7.4 |
| ample 24 | | | | | | | | | | | | | | | | | | | |
| Ex- | 86.7 | 3.5 | 1.0 | 0.8 | 0.0 | 5.0 | 3.0 | 0.0 | 0.0 | 0.0 | 0.0 | 0.0 | 86.7 | 91.7 | 91.7 | — | 0.0 | 15.0 | 6.5 |
| ample 25 | | | | | | | | | | | | | | | | | | | |
| Ex- | 86.1 | 0.5 | 1.0 | 1.1 | 0.3 | 8.0 | 3.0 | 0.0 | 0.0 | 0.0 | 0.0 | 0.0 | 86.1 | 94.1 | — | 82.1 | 0.0 | 24.0 | 3.5 |
| ample 26 | | | | | | | | | | | | | | | | | | | |
| Ex- | 88.0 | 2.0 | 1.2 | 0.6 | 1.2 | 3.0 | 4.0 | 0.0 | 0.0 | 0.0 | 0.0 | 0.0 | 88.0 | 91.0 | 91.0 | — | 0.0 | 12.0 | 6.0 |
| ample 27 | | | | | | | | | | | | | | | | | | | |
| Ex- | 85.0 | 1.0 | 0.9 | 1.0 | 0.6 | 9.0 | 2.5 | 0.0 | 0.0 | 0.0 | 0.0 | 0.0 | 85.0 | 94.0 | — | 80.5 | 0.0 | 22.5 | 3.5 |
| ample 28 | | | | | | | | | | | | | | | | | | | |
| Ex- | 96.5 | 0.0 | 1.2 | 0.7 | 0.1 | 0.5 | 1.0 | 0.0 | 0.0 | 0.0 | 0.0 | 0.0 | 96.5 | 97.0 | 97.0 | — | 0.0 | 0.5 | 1.0 |
| ample 29 | | | | | | | | | | | | | | | | | | | |
| Ex- | 90.0 | 1.1 | 1.5 | 1.6 | 2.5 | 0.3 | 3.0 | 0.0 | 0.0 | 0.0 | 0.0 | 0.0 | 90.0 | 90.3 | 90.3 | — | 0.0 | 0.9 | 4.1 |
| ample 30 | | | | | | | | | | | | | | | | | | | |
| Ex- | 88.0 | 1.8 | 3.0 | 3.0 | 1.5 | 2.5 | 0.2 | 0.0 | 0.0 | 0.0 | 0.0 | 0.0 | 88.0 | 90.5 | 90.5 | — | 0.0 | 0.5 | 2.0 |
| ample 31 | | | | | | | | | | | | | | | | | | | |
| Ex- | 87.0 | 3.7 | 1.0 | 3.0 | 2.1 | 3.0 | 0.2 | 0.0 | 0.0 | 0.0 | 0.0 | 0.0 | 87.0 | 90.0 | 90.0 | — | 0.0 | 0.6 | 3.9 |
| ample 32 | | | | | | | | | | | | | | | | | | | |
| Ex- | 87.0 | 0.5 | 5.0 | 2.8 | 1.0 | 3.0 | 0.7 | 0.0 | 0.0 | 0.0 | 0.0 | 0.0 | 87.0 | 90.0 | 90.0 | — | 0.0 | 2.1 | 1.2 |
| ample 33 | | | | | | | | | | | | | | | | | | | |
| Ex- | 86.0 | 0.9 | 5.0 | 2.0 | 2.0 | 3.6 | 0.5 | 0.0 | 0.0 | 0.0 | 0.0 | 0.0 | 86.0 | 89.8 | 89.8 | — | 0.0 | 1.8 | 1.4 |
| ample 34 | | | | | | | | | | | | | | | | | | | |
| Ex- | 83.4 | 2.0 | 4.6 | 1.0 | 0.0 | 7.5 | 1.5 | 0.0 | 0.0 | 0.0 | 0.0 | 0.0 | 83.4 | 90.9 | — | 79.7 | 0.0 | 11.3 | 3.5 |
| ample 35 | | | | | | | | | | | | | | | | | | | |
| Ex- | 85.0 | 4.0 | 2.0 | 1.2 | 1.2 | 5.3 | 1.3 | 0.0 | 0.0 | 0.0 | 0.0 | 0.0 | 85.0 | 90.3 | 90.3 | — | 0.0 | 6.9 | 5.3 |
| ample 36 | | | | | | | | | | | | | | | | | | | |
| Ex- | 82.2 | 3.5 | 2.4 | 1.6 | 2.1 | 7.4 | 0.8 | 0.0 | 0.0 | 0.0 | 0.0 | 0.0 | 82.2 | 89.6 | 89.6 | — | 0.0 | 5.9 | 4.3 |
| ample 37 | | | | | | | | | | | | | | | | | | | |
| Ex- | 92.5 | 0.5 | 1.0 | 1.0 | 0.5 | 4.0 | 0.5 | 0.0 | 0.0 | 0.0 | 0.0 | 0.0 | 92.5 | 96.5 | 96.5 | — | 0.0 | 2.0 | 1.0 |
| ample 38 | | | | | | | | | | | | | | | | | | | |
| Ex- | 86.0 | 0.5 | 1.5 | 1.5 | 6.0 | 4.0 | 0.5 | 0.0 | 0.0 | 0.0 | 0.0 | 0.0 | 86.0 | 90.0 | 90.0 | — | 0.0 | 2.0 | 1.0 |
| ample 39 | | | | | | | | | | | | | | | | | | | |
| Ex- | 85.5 | 1.0 | 1.1 | 0.7 | 0.0 | 11.0 | 0.7 | 0.0 | 0.0 | 0.0 | 0.0 | 0.0 | 85.5 | 96.5 | — | 80.0 | 0.0 | 7.7 | 1.7 |
| ample 40 | | | | | | | | | | | | | | | | | | | |
| Ex- | 84.5 | 1.0 | 0.9 | 0.7 | 0.7 | 12.0 | 0.2 | 0.0 | 0.0 | 0.0 | 0.0 | 0.0 | 84.5 | 96.5 | — | 78.5 | 0.0 | 2.4 | 1.2 |
| ample 41 | | | | | | | | | | | | | | | | | | | |
| Ex- | 88.0 | 2.5 | 1.2 | 0.4 | 0.5 | 4.1 | 3.3 | 0.0 | 0.0 | 0.0 | 0.0 | 0.0 | 88.0 | 92.1 | 92.1 | — | 0.0 | 13.5 | 5.8 |
| ample 42 | | | | | | | | | | | | | | | | | | | |
| Ex- | 88.3 | 4.5 | 0.7 | 1.4 | 0.5 | 2.1 | 2.5 | 0.0 | 0.0 | 0.0 | 0.0 | 0.0 | 88.3 | 90.4 | 90.4 | — | 0.0 | 5.3 | 7.0 |
| ample 43 | | | | | | | | | | | | | | | | | | | |
| Ex- | 88.0 | 0.0 | 0.5 | 1.0 | 6.0 | 4.0 | 0.5 | 0.0 | 0.0 | 0.0 | 0.0 | 0.0 | 88.0 | 92.0 | 92.0 | — | 0.0 | 2.0 | 0.5 |
| ample 44 | | | | | | | | | | | | | | | | | | | |
| Ex- | 91.0 | 0.0 | 0.5 | 1.0 | 5.0 | 2.0 | 0.5 | 0.0 | 0.0 | 0.0 | 0.0 | 0.0 | 91.0 | 93.0 | 93.0 | — | 0.0 | 1.0 | 0.5 |
| ample 45 | | | | | | | | | | | | | | | | | | | |
| Ex- | 91.0 | 0.0 | 0.5 | 1.0 | 3.2 | 4.0 | 0.3 | 0.0 | 0.0 | 0.0 | 0.0 | 0.0 | 91.0 | 95.0 | 95.0 | — | 0.0 | 1.2 | 0.3 |
| ample 46 | | | | | | | | | | | | | | | | | | | |
| Ex- | 89.0 | 0.0 | 0.5 | 1.0 | 6.7 | 2.6 | 0.2 | 0.0 | 0.0 | 0.0 | 0.0 | 0.0 | 89.0 | 91.6 | 91.6 | — | 0.0 | 0.5 | 0.2 |
| ample 47 | | | | | | | | | | | | | | | | | | | |
| Ex- | 90.0 | 0.0 | 0.8 | 0.9 | 1.0 | 6.3 | 1.0 | 0.0 | 0.0 | 0.0 | 0.0 | 0.0 | 90.0 | 96.3 | 96.3 | — | 0.0 | 6.3 | 1.0 |
| ample 48 | | | | | | | | | | | | | | | | | | | |
| Ex- | 84.3 | 0.2 | 0.8 | 0.5 | 0.2 | 11.0 | 3.0 | 0.0 | 0.0 | 0.0 | 0.0 | 0.0 | 84.3 | 95.3 | — | 78.8 | 0.0 | 33.0 | 3.2 |
| ample 49 | | | | | | | | | | | | | | | | | | | |
| Ex- | 85.0 | 0.5 | 1.0 | 0.9 | 0.6 | 10.0 | 2.0 | 0.0 | 0.0 | 0.0 | 0.0 | 0.0 | 85.0 | 95.0 | — | 80.0 | 0.0 | 20.0 | 2.5 |
| ample 50 | | | | | | | | | | | | | | | | | | | |
| Ex- | 86.2 | 3.0 | 1.1 | 0.7 | 1.0 | 6.0 | 1.0 | 0.0 | 0.0 | 1.0 | 0.0 | 0.0 | 86.2 | 92.2 | 92.2 | — | 1.0 | 6.0 | 4.0 |
| ample 51 | | | | | | | | | | | | | | | | | | | |
| Ex- | 86.2 | 3.0 | 1.1 | 0.7 | 1.0 | 6.0 | 1.0 | 0.0 | 0.0 | 0.0 | 1.0 | 0.0 | 86.2 | 92.2 | 92.2 | — | 1.0 | 6.0 | 4.0 |
| ample 52 | | | | | | | | | | | | | | | | | | | |
| Ex- | 86.2 | 3.0 | 1.1 | 0.7 | 1.0 | 6.0 | 1.0 | 0.0 | 0.0 | 0.0 | 0.0 | 1.0 | 86.2 | 92.2 | 92.2 | — | 1.0 | 6.0 | 4.0 |
| ample 53 | | | | | | | | | | | | | | | | | | | |
| Ex- | 86.2 | 0.8 | 1.1 | 0.7 | 1.0 | 5.0 | 1.0 | 0.0 | 4.2 | 0.0 | 0.0 | 0.0 | 86.2 | 91.2 | 91.2 | — | 4.2 | 5.0 | 1.8 |
| ample 54 | | | | | | | | | | | | | | | | | | | |
| Ex- | 58.0 | 1.5 | 3.0 | 3.0 | 1.5 | 2.5 | 0.5 | 30.0 | 0.0 | 0.0 | 0.0 | 0.0 | 88.0 | 90.5 | 90.5 | — | 0.0 | 1.3 | 2.0 |
| ample 55 | | | | | | | | | | | | | | | | | | | |

TABLE 2

| | Volume | Saturation | | Corrosion | | |
|---|---|---|---|---|---|---|
| | ratio of | magnetic | Corrosion | current | | Coercive |
| | amorphous | flux | potential | density | | force |
| | phase | density | E_{corr} | i_{corr} | D50 | Hc |
| | Va [%] | Bs [J] | [mV] | [A/m²] | [μm] | [A/m] |
| Example 1 | 30 | 1.59 | −613 | 3.8 | 21 | 852 |
| Example 2 | 93 | 1.54 | −484 | 3.0 | 19 | 595 |
| Example 3 | 88 | 1.61 | −570 | 2.5 | 27 | 803 |
| Example 4 | 93 | 1.55 | −482 | 2.3 | 25 | 702 |
| Example 5 | 87 | 1.53 | −492 | 2.3 | 18 | 884 |
| Example 6 | 100 | 1.61 | −584 | 3.0 | 25 | 297 |
| Example 7 | 81 | 1.55 | −581 | 4.2 | 28 | 999 |
| Example 8 | 100 | 1.49 | −471 | 3.5 | 25 | 216 |
| Example 9 | 82 | 1.47 | −584 | 4.8 | 21 | 897 |
| Example 10 | 80 | 1.62 | −599 | 4.6 | 30 | 757 |
| Example 11 | 83 | 1.47 | −413 | 2.6 | 25 | 817 |
| Example 12 | 84 | 1.52 | −455 | 2.9 | 22 | 941 |
| Example 13 | 90 | 1.48 | −512 | 4.6 | 20 | 854 |
| Example 14 | 90 | 1.44 | −477 | 2.5 | 19 | 730 |
| Example 15 | 95 | 1.60 | −543 | 4.5 | 20 | 541 |
| Example 16 | 80 | 1.45 | −595 | 3.8 | 26 | 883 |
| Example 17 | 94 | 1.58 | −575 | 3.9 | 26 | 386 |
| Example 18 | 80 | 1.52 | −570 | 2.5 | 18 | 868 |
| Example 19 | 81 | 1.57 | −427 | 2.7 | 28 | 929 |
| Example 20 | 85 | 1.55 | −499 | 3.1 | 24 | 961 |
| Example 21 | 80 | 1.50 | 579 | 4.6 | 29 | 887 |
| Example 22 | 87 | 1.52 | −583 | 4.0 | 17 | 921 |
| Example 23 | 95 | 1.48 | −578 | 4.6 | 23 | 472 |
| Example 24 | 92 | 1.46 | −472 | 2.0 | 29 | 630 |
| Example 25 | 85 | 1.46 | −444 | 2.5 | 27 | 850 |
| Example 26 | 80 | 1.55 | −419 | 2.5 | 24 | 810 |
| Example 27 | 86 | 1.63 | −396 | 2.3 | 22 | 886 |
| Example 28 | 83 | 1.54 | −480 | 2.4 | 26 | 862 |
| Example 29 | 70 | 1.68 | −515 | 4.3 | 30 | 759 |
| Example 30 | 75 | 1.41 | −502 | 3.6 | 29 | 773 |
| Example 31 | 100 | 1.44 | −527 | 4.5 | 23 | 318 |
| Example 32 | 73 | 1.40 | −519 | 4.6 | 23 | 743 |
| Example 33 | 81 | 1.44 | −573 | 4.0 | 22 | 804 |
| Example 34 | 100 | 1.40 | −579 | 4.3 | 29 | 378 |
| Example 35 | 77 | 1.44 | −563 | 2.4 | 27 | 805 |
| Example 36 | 85 | 1.47 | −566 | 2.2 | 22 | 674 |
| Example 37 | 78 | 1.42 | −505 | 3.7 | 31 | 644 |
| Example 38 | 81 | 1.56 | −507 | 4.7 | 25 | 742 |
| Example 39 | 72 | 1.42 | −593 | 4.5 | 32 | 767 |
| Example 40 | 72 | 1.56 | −488 | 3.6 | 28 | 803 |
| Example 41 | 83 | 1.54 | −543 | 3.5 | 26 | 943 |
| Example 42 | 81 | 1.65 | −437 | 2.5 | 25 | 883 |
| Example 43 | 85 | 1.54 | −539 | 2.8 | 25 | 957 |
| Example 44 | 90 | 1.51 | −596 | 4.2 | 26 | 547 |
| Example 45 | 91 | 1.57 | −586 | 4.7 | 27 | 618 |
| Example 46 | 93 | 1.60 | −595 | 4.8 | 23 | 817 |
| Example 47 | 87 | 1.49 | −592 | 4.8 | 26 | 791 |
| Example 48 | 93 | 1.64 | −454 | 3.7 | 23 | 745 |
| Example 49 | 81 | 1.59 | −367 | 2.7 | 25 | 931 |
| Example 50 | 79 | 1.69 | −480 | 2.9 | 22 | 977 |
| Example 51 | 80 | 1.45 | −445 | 3.9 | 26 | 715 |
| Example 52 | 82 | 1.43 | −427 | 4.1 | 23 | 912 |
| Example 53 | 77 | 1.45 | −426 | 4.8 | 24 | 882 |
| Example 54 | 94 | 1.41 | −362 | 4.0 | 24 | 882 |
| Example 55 | 100 | 1.52 | −471 | 4.4 | 27 | 364 |

TABLE 3

| | | | | | | | | | | | | | | | Total |
|---|---|---|---|---|---|---|---|---|---|---|---|---|---|---|---|
| | | | | | | | | | | | | | | | content |
| | | | | | | | | | | | | | | | of Fe, |
| | | | | | | | | | | | | | | | Co, Ni |
| | | | | | | | | | | | | | | | (when |
| | | | | | | | | | | | | | | | the Ni |
| | | | | | | | | | | | | | | | content |
| | | | | | | | | | | | | | | Total | is 7.4 |
| | | | | | | | | | | | | | Total | content | parts by |
| | | | | | | | | | | | | | content | of | mass or |
| | | | | | | | | | | | | | of Fe | Fe, Co, | less) |
| | | | | | | | | | | | | | and Co | and Ni | [parts |
| | Chemical composition [parts by mass] | | | | | | | | | | | | [parts | [parts by | by |
| | Fe | P | B | C | Si | Ni | Cr | Co | Mo | W | Zr | Nb | by mass] | mass] | mass] |
| Com- | 87.6 | 4.0 | 0.5 | 0.9 | 0.0 | 3.0 | 4.0 | 0.0 | 0.0 | 0.0 | 0.0 | 0.0 | 87.6 | 90.6 | 90.5 |
| parative | | | | | | | | | | | | | | | |
| Ex- | | | | | | | | | | | | | | | |
| ample 1 | | | | | | | | | | | | | | | |
| Com- | 82.0 | 1.9 | 2.0 | 1.7 | 2.0 | 8.2 | 2.2 | 0.0 | 0.0 | 0.0 | 0.0 | 0.0 | 82.0 | 90.2 | — |
| parative | | | | | | | | | | | | | | | |
| Ex- | | | | | | | | | | | | | | | |
| ample 2 | | | | | | | | | | | | | | | |
| Com- | 82.0 | 1.7 | 1.0 | 1.1 | 7.0 | 7.0 | 0.2 | 0.0 | 0.0 | 0.0 | 0.0 | 0.0 | 82.0 | 89.0 | 89.0 |
| parative | | | | | | | | | | | | | | | |
| Ex- | | | | | | | | | | | | | | | |
| ample 3 | | | | | | | | | | | | | | | |
| Com- | 96.8 | 0.4 | 0.4 | 0.4 | 0.3 | 0.4 | 1.3 | 0.0 | 0.0 | 0.0 | 0.0 | 0.0 | 96.8 | 87.2 | 97.2 |
| parative | | | | | | | | | | | | | | | |
| Ex- | | | | | | | | | | | | | | | |
| ample 4 | | | | | | | | | | | | | | | |
| Com- | 86.6 | 4.8 | 1.0 | 0.9 | 1.0 | 3.2 | 2.5 | 0.0 | 0.0 | 0.0 | 0.0 | 0.0 | 86.6 | 89.88 | 89.8 |
| parative- | | | | | | | | | | | | | | | |
| Ex- | | | | | | | | | | | | | | | |
| ample 5 | | | | | | | | | | | | | | | |
| Com- | 85.8 | 1.0 | 5.4 | 2.0 | 0.3 | 4.5 | 1.0 | 0.0 | 0.0 | 0.0 | 0.0 | 0.0 | 85.8 | 90.3 | 90.3 |
| parative | | | | | | | | | | | | | | | |
| Ex- | | | | | | | | | | | | | | | |
| ample 6 | | | | | | | | | | | | | | | |
| Com- | 88.0 | 0.8 | 0.7 | 5.5 | 0.5 | 4.0 | 0.5 | 0.0 | 0.0 | 0.0 | 0.0 | 0.0 | 88.0 | 92.0 | 92.0 |
| parative | | | | | | | | | | | | | | | |
| Ex- | | | | | | | | | | | | | | | |
| ample 7 | | | | | | | | | | | | | | | |
| Com- | 86.1 | 0.5 | 3.0 | 4.0 | 0.5 | 5.0 | 0.9 | 0.0 | 0.0 | 0.0 | 0.0 | 0.0 | 86.1 | 91.1 | 91.1 |
| parative | | | | | | | | | | | | | | | |
| Ex- | | | | | | | | | | | | | | | |
| ample 8 | | | | | | | | | | | | | | | |
| Com- | 88.0 | 1.0 | 0.5 | 1.0 | 7.0 | 2.0 | 0.5 | 0.0 | 0.0 | 0.0 | 0.0 | 0.0 | 88.0 | 90.0 | 90.0 |
| parative | | | | | | | | | | | | | | | |
| Ex- | | | | | | | | | | | | | | | |
| ample 9 | | | | | | | | | | | | | | | |
| Com- | 84.8 | 0.0 | 1.0 | 0.5 | 0.9 | 12.5 | 0.3 | 0.0 | 0.0 | 0.0 | 0.0 | 0.0 | 84.8 | 97.3 | — |
| parative | | | | | | | | | | | | | | | |
| Ex- | | | | | | | | | | | | | | | |
| ample | | | | | | | | | | | | | | | |
| 10 | | | | | | | | | | | | | | | |
| Com- | 84.8 | 0.00 | 0.3 | 0.3 | 0.1 | 12.5 | 2.0 | 0.0 | 0.0 | 0.0 | 0.0 | 0.0 | 84.8 | 97.3 | — |
| parative | | | | | | | | | | | | | | | |
| Ex- | | | | | | | | | | | | | | | |
| ample | | | | | | | | | | | | | | | |
| 11 | | | | | | | | | | | | | | | |
| Com- | 84.0 | 0.0 | 1.3 | 0.7 | 0.5 | 9.0 | 4.5 | 0.0 | 0.0 | 0.0 | 0.0 | 0.0 | 84.0 | 93.0 | — |
| parative | | | | | | | | | | | | | | | |
| Ex- | | | | | | | | | | | | | | | |
| ample | | | | | | | | | | | | | | | |
| 12 | | | | | | | | | | | | | | | |
| Com- | 85.6 | 1.5 | 1.5 | 1.0 | 1.5 | 4.2 | 4.7 | 0.0 | 0.0 | 0.0 | 0.0 | 0.0 | 85.6 | 89.8 | 89.8 |
| parative | | | | | | | | | | | | | | | |
| Ex- | | | | | | | | | | | | | | | |
| ample | | | | | | | | | | | | | | | |
| 13 | | | | | | | | | | | | | | | |
| Com- | 87.5 | 2.9 | 1.0 | 1.3 | 0.5 | 2.1 | 4.7 | 0.0 | 0.0 | 0.0 | 0.0 | 0.0 | 87.5 | 89.6 | 89.6 |
| parative | | | | | | | | | | | | | | | |
| Ex- | | | | | | | | | | | | | | | |
| ample | | | | | | | | | | | | | | | |
| 14 | | | | | | | | | | | | | | | |
| Com- | 89.8 | 2.0 | 1.6 | 0.6 | 1.0 | 0.5 | 4.5 | 0.0 | 0.0 | 0.0 | 0.0 | 0.0 | 89.8 | 90.3 | 90.3 |
| parative | | | | | | | | | | | | | | | |
| Ex- | | | | | | | | | | | | | | | |
| ample | | | | | | | | | | | | | | | |
| 15 | | | | | | | | | | | | | | | |
| Com- | 93.0 | 0.3 | 1.3 | 0.8 | 2.4 | 0.2 | 2.0 | 0.0 | 0.0 | 0.0 | 0.0 | 0.0 | 93.0 | 93.2 | 93.2 |
| parative | | | | | | | | | | | | | | | |
| Ex- | | | | | | | | | | | | | | | |
| ample | | | | | | | | | | | | | | | |
| 16 | | | | | | | | | | | | | | | |
| Com- | 93.0 | 1.5 | 1.1 | 0.9 | 2.2 | 1.0 | 0.3 | 0.0 | 0.0 | 0.0 | 0.0 | 0.0 | 93.0 | 94.0 | 94.0 |
| parative | | | | | | | | | | | | | | | |
| Ex- | | | | | | | | | | | | | | | |
| ample | | | | | | | | | | | | | | | |
| 17 | | | | | | | | | | | | | | | |
| Com- | 95.0 | 0.6 | 1.6 | 0.5 | 1.0 | 0.7 | 0.6 | 0.0 | 0.0 | 0.0 | 0.0 | 0.0 | 95.0 | 95.7 | 95.7 |
| parative | | | | | | | | | | | | | | | |
| Ex- | | | | | | | | | | | | | | | |
| ample | | | | | | | | | | | | | | | |
| 18 | | | | | | | | | | | | | | | |
| Com- | 93.8 | 0.5 | 1.0 | 0.2 | 0.0 | 4.0 | 0.5 | 0.0 | 0.0 | 0.0 | 0.0 | 0.0 | 93.8 | 97.8 | 97.8 |
| parative | | | | | | | | | | | | | | | |
| Ex- | | | | | | | | | | | | | | | |
| ample | | | | | | | | | | | | | | | |
| 19 | | | | | | | | | | | | | | | |
| Com- | 91.6 | 0.0 | 1.5 | 0.0 | 0.0 | 6.5 | 0.4 | 0.0 | 0.0 | 0.0 | 0.0 | 0.0 | 91.6 | 98.1 | 98.1 |
| parative | | | | | | | | | | | | | | | |
| Ex- | | | | | | | | | | | | | | | |
| ample | | | | | | | | | | | | | | | |
| 20 | | | | | | | | | | | | | | | |
| Com- | 86.5 | 4.0 | 1.7 | 1.1 | 4.0 | 2.5 | 0.2 | 0.0 | 0.0 | 0.0 | 0.0 | 0.0 | 86.5 | 89.0 | 89.0 |
| parative | | | | | | | | | | | | | | | |
| Ex- | | | | | | | | | | | | | | | |
| ample | | | | | | | | | | | | | | | |
| 21 | | | | | | | | | | | | | | | |
| Com- | 84.0 | 4.0 | 1.7 | 1.1 | 4.0 | 5.0 | 0.2 | 0.0 | 0.0 | 0.0 | 0.0 | 0.0 | 84.0 | 89.0 | 89.0 |
| parative | | | | | | | | | | | | | | | |
| Ex- | | | | | | | | | | | | | | | |
| ample | | | | | | | | | | | | | | | |
| 22 | | | | | | | | | | | | | | | |
| Com- | 83.0 | 1.3 | 2.0 | 0.7 | 2.0 | 10.0 | 1.0 | 0.0 | 0.0 | 0.0 | 0.0 | 0.0 | 83.0 | 93.0 | — |
| parative | | | | | | | | | | | | | | | |
| Ex- | | | | | | | | | | | | | | | |
| ample | | | | | | | | | | | | | | | |
| 23 | | | | | | | | | | | | | | | |
| Com- | 85.8 | 0.5 | 3.6 | 4.8 | 0.3 | 4.0 | 1.0 | 0.0 | 0.0 | 0.0 | 0.0 | 0.0 | 85.8 | 89.8 | 89.8 |
| parative | | | | | | | | | | | | | | | |
| Ex- | | | | | | | | | | | | | | | |
| ample | | | | | | | | | | | | | | | |
| 24 | | | | | | | | | | | | | | | |
| Com- | 84.0 | 0.5 | 3.2 | 0.5 | 0.3 | 6.0 | 1.0 | 0.0 | 0.0 | 0.0 | 0.0 | 4.5 | 84.0 | 90.0 | 90.0 |
| parative | | | | | | | | | | | | | | | |
| Ex- | | | | | | | | | | | | | | | |
| ample | | | | | | | | | | | | | | | |
| 25 | | | | | | | | | | | | | | | |
| Com- | 86.5 | 2.5 | 1.5 | 1.0 | 1.5 | 7.0 | 0.0 | 0.0 | 0.0 | 0.0 | 0.0 | 0.0 | 86.5 | 93.5 | 93.5 |
| parative | | | | | | | | | | | | | | | |
| Ex- | | | | | | | | | | | | | | | |
| ample | | | | | | | | | | | | | | | |
| 26 | | | | | | | | | | | | | | | |
| Com- | 57.0 | 1.5 | 3.0 | 3.0 | 1.5 | 2.5 | 0.5 | 31.0 | 0.0 | 0.0 | 0.0 | 0.0 | 88.0 | 90.5 | 90.5 |
| parative | | | | | | | | | | | | | | | |
| Ex- | | | | | | | | | | | | | | | |
| ample | | | | | | | | | | | | | | | |
| 27 | | | | | | | | | | | | | | | |
| Com- | 89.5 | 0.0 | 0.0 | 1.0 | 6.7 | 2.6 | 0.2 | 0.0 | 0.0 | 0.0 | 0.0 | 0.0 | 89.5 | 92.1 | 92.1 |
| parative | | | | | | | | | | | | | | | |
| Ex- | | | | | | | | | | | | | | | |
| ample | | | | | | | | | | | | | | | |
| 28 | | | | | | | | | | | | | | | |
| Com- | 90.3 | 1.1 | 1.5 | 1.6 | 2.5 | 0.0 | 3.0 | 0.0 | 0.0 | 0.0 | 0.0 | 0.0 | 90.3 | 90.3 | 90.3 |
| parative | | | | | | | | | | | | | | | |
| Ex- | | | | | | | | | | | | | | | |
| ample | | | | | | | | | | | | | | | |
| 29 | | | | | | | | | | | | | | | |
| Com- | 90.0 | 1.1 | 1.5 | 1.6 | 2.5 | 0.3 | 3.0 | 0.0 | 0.0 | 0.0 | 0.0 | 0.0 | 90.0 | 90.3 | 90.3 |
| parative | | | | | | | | | | | | | | | |
| Ex- | | | | | | | | | | | | | | | |
| ample | | | | | | | | | | | | | | | |
| 30 | | | | | | | | | | | | | | | |
| | Difference | | | | | | | | | | | | | | |
| | obtained by | | | | | | | | | | | | | | |
| | subtracting | | | | | | | | | | | | | | |
| | the | | | | | | | | | | | | | | |
| | multiplication | | | | | | | | | | | | | | |
| | product of | | | | | | | | | | | | | | |
| | parts by | | | | | | | | | | | | | | |
| | mass of | | | | | | | | | | | | | | |
| | Ni × 0.5 | | | | | | | | | | | | | | |
| | from the total | | | | | | | | | | | | | | |
| | parts by mass | | | | | | | | | | | | | | |
| | of Fe and Co | | Multi- | | Vol- | | | | | | | | | | |
| | (when the Ni | Total | plication | Total | ume | | | | | | | | | | |

| | | | | | |
|---|---|---|---|---|---|
| content | content | product | content | ratio | Sat- |

| | | | | | | | | |
|---|---|---|---|---|---|---|---|---|
| is higher | of Mo, | of the | of of P | of | uration | Corr | Corrosion | |
| than 7.4 parts | W, Zr, | parts by | and Cr | amor- | magnetic | osion | current | |
| by mass) | and Nb | mass of | [parts | phous | flux | potential | density | Coercive |

| | [parts by | [parts | Ni and | by | phase | denisty | E_{corr} | i_{corr} | D50 | force Hc |
|---|---|---|---|---|---|---|---|---|---|---|
| | mass] | by mass] | Cr | mass] | Va [%] | Bs [J] | [mV] | [A/m²] | [μm] | [A/m] |
| Com- | — | 0.0 | 12.0 | 8.0 | 94 | 1.36 | −460 | 2.0 | 27 | 596 |
| parative | | | | | | | | | | |
| Ex- | | | | | | | | | | |
| ample 1 | | | | | | | | | | |
| Com- | 77.9 | 0.0 | 18.0 | 4.1 | 100 | 1.38 | −459 | 2.2 | 25 | 266 |
| parative | | | | | | | | | | |
| Ex- | | | | | | | | | | |
| ample 2 | | | | | | | | | | |
| Com- | — | 0.0 | 1.4 | 1.9 | 100 | 1.35 | −591 | 3.7 | 28 | 387 |
| parative | | | | | | | | | | |
| Ex- | | | | | | | | | | |
| ample 3 | | | | | | | | | | |
| Com- | — | 0.0 | 0.5 | 1.7 | 53 | 1.69 | −511 | 4.7 | 25 | 1836 |
| parative | | | | | | | | | | |
| Ex- | | | | | | | | | | |
| ample 4 | | | | | | | | | | |
| Com- | — | 0.0 | 8.0 | 7.3 | 83 | 1.39 | −540 | 2.6 | 30 | 488 |
| parative- | | | | | | | | | | |
| Ex- | | | | | | | | | | |
| ample 5 | | | | | | | | | | |
| Com- | — | 0.0 | 4.5 | 2.0 | 100 | 1.36 | −591 | 3.8 | 20 | 382 |
| parative | | | | | | | | | | |
| Ex- | | | | | | | | | | |
| ample 6 | | | | | | | | | | |
| Com- | — | 0.0 | 2.0 | 1.3 | 45 | 1.39 | −590 | 4.4 | 25 | 2467 |
| parative | | | | | | | | | | |
| Ex- | | | | | | | | | | |
| ample 7 | | | | | | | | | | |
| Com- | — | 0.0 | 4.5 | 1.4 | 71 | 1.31 | −482 | 3.8 | 30 | 936 |
| parative | | | | | | | | | | |
| Ex- | | | | | | | | | | |
| ample 8 | | | | | | | | | | |
| Com- | — | 0.0 | 1.0 | 1.5 | 100 | 1.34 | −588 | 4.8 | 28 | 300 |
| parative | | | | | | | | | | |
| Ex- | | | | | | | | | | |
| ample 9 | | | | | | | | | | |
| Com- | 78.6 | 0.0 | 3.8 | 0.3 | 54 | 1.32 | −523 | 2.7 | 27 | 1452 |
| parative | | | | | | | | | | |
| Ex- | | | | | | | | | | |
| ample | | | | | | | | | | |
| 10 | | | | | | | | | | |
| Com- | 78.6 | 0.0 | 25.0 | 2.0 | 55 | 1.37 | −530 | 2.5 | 28 | 1346 |
| parative | | | | | | | | | | |
| Ex- | | | | | | | | | | |
| ample | | | | | | | | | | |
| 11 | | | | | | | | | | |
| Com- | 79.5 | 0.0 | 40.5 | 4.5 | 75 | 1.34 | −422 | 1.8 | 25 | 1099 |
| parative | | | | | | | | | | |
| Ex- | | | | | | | | | | |
| ample | | | | | | | | | | |
| 12 | | | | | | | | | | |
| Com- | — | 0.0 | 19.7 | 6.2 | 100 | 1.39 | −514 | 1.7 | 24 | 503 |
| parative | | | | | | | | | | |
| Ex- | | | | | | | | | | |
| ample | | | | | | | | | | |
| 13 | | | | | | | | | | |
| Com- | — | 0.0 | 9.9 | 7.6 | 82 | 1.37 | −527 | 1.9 | 21 | 1333 |
| parative | | | | | | | | | | |
| Ex- | | | | | | | | | | |
| ample | | | | | | | | | | |
| 14 | | | | | | | | | | |
| Com- | — | 0.0 | 2.3 | 6.5 | 74 | 1.36 | −473 | 1.9 | 24 | 637 |
| parative | | | | | | | | | | |
| Ex- | | | | | | | | | | |
| ample | | | | | | | | | | |
| 15 | | | | | | | | | | |
| Com- | — | 0.0 | 0.4 | 2.3 | 93 | 1.65 | −744 | 5.0 | 25 | 732 |
| parative | | | | | | | | | | |
| Ex- | | | | | | | | | | |
| ample | | | | | | | | | | |
| 16 | | | | | | | | | | |
| Com- | — | 0.0 | 0.3 | 1.8 | 95 | 1.55 | −846 | 5.8 | 27 | 478 |
| parative | | | | | | | | | | |
| Ex- | | | | | | | | | | |
| ample | | | | | | | | | | |
| 17 | | | | | | | | | | |
| Com- | — | 0.0 | 0.4 | 1.2 | 83 | 1.57 | −678 | 6.0 | 24 | 764 |
| parative | | | | | | | | | | |
| Ex- | | | | | | | | | | |
| ample | | | | | | | | | | |
| 18 | | | | | | | | | | |
| Com- | — | 0.0 | 2.0 | 1.0 | 63 | 1.52 | −581 | 4.4 | 33 | 1101 |
| parative | | | | | | | | | | |
| Ex- | | | | | | | | | | |
| ample | | | | | | | | | | |
| 19 | | | | | | | | | | |
| Com- | — | 0.0 | 2.6 | 0.4 | 68 | 1.49 | −587 | 4.4 | 33 | 1373 |
| parative | | | | | | | | | | |
| Ex- | | | | | | | | | | |
| ample | | | | | | | | | | |
| 20 | | | | | | | | | | |
| Com- | — | 0.0 | 0.5 | 4.2 | 100 | 1.37 | −542 | 4.0 | 30 | 273 |
| parative | | | | | | | | | | |
| Ex- | | | | | | | | | | |
| ample | | | | | | | | | | |
| 21 | | | | | | | | | | |
| Com- | — | 0.0 | 1.0 | 4.2 | 100 | 1.34 | −586 | 4.6 | 29 | 453 |
| parative | | | | | | | | | | |
| Ex- | | | | | | | | | | |
| ample | | | | | | | | | | |
| 22 | | | | | | | | | | |
| Com- | 78.0 | 0.0 | 10.0 | 2.3 | 100 | 1.36 | −455 | 2.5 | 26 | 484 |
| parative | | | | | | | | | | |
| Ex- | | | | | | | | | | |
| ample | | | | | | | | | | |
| 23 | | | | | | | | | | |
| Com- | — | 0.0 | 4.0 | 1.5 | 100 | 1.37 | −543 | 3.0 | 23 | 244 |
| parative | | | | | | | | | | |
| Ex- | | | | | | | | | | |
| ample | | | | | | | | | | |
| 24 | | | | | | | | | | |
| Com- | — | 4.5 | 6.0 | 1.5 | 100 | 1.38 | −374 | 3.1 | 22 | 341 |
| parative | | | | | | | | | | |
| Ex- | | | | | | | | | | |
| ample | | | | | | | | | | |
| 25 | | | | | | | | | | |
| Com- | — | 0.0 | 0.0 | 2.5 | 100 | 1.51 | −629 | 4.5 | 22 | 538 |
| parative | | | | | | | | | | |
| Ex- | | | | | | | | | | |
| ample | | | | | | | | | | |
| 26 | | | | | | | | | | |
| Com- | — | 0.0 | 1.3 | 2.0 | 87 | 1.52 | −471 | 4.4 | 27 | 1258 |
| parative | | | | | | | | | | |
| Ex- | | | | | | | | | | |
| ample | | | | | | | | | | |
| 27 | | | | | | | | | | |
| Com- | — | 0.0 | 0.5 | 0.2 | 87 | 1.49 | −592 | 4.8 | 26 | 1291 |
| parative | | | | | | | | | | |
| Ex- | | | | | | | | | | |
| ample | | | | | | | | | | |
| 28 | | | | | | | | | | |
| Com- | — | 0.0 | 0.0 | 4.1 | 77 | 1.41 | −612 | 6.6 | 27 | 755 |
| parative | | | | | | | | | | |
| Ex- | | | | | | | | | | |
| ample | | | | | | | | | | |
| 29 | | | | | | | | | | |
| Com- | — | 0.0 | 0.9 | 4.1 | 65 | 1.42 | −653 | 6.4 | 35 | 1055 |
| parative | | | | | | | | | | |
| Ex- | | | | | | | | | | |
| ample | | | | | | | | | | |
| 30 | | | | | | | | | | |

In Examples 1 to 55, the alloy particles have the chemical composition and the structure of the present disclosure, and have a high saturation magnetic flux density Bs and an excellent corrosion resistance.

In Comparative Example 1, the saturation magnetic flux density Bs is low because the total content of P and Cr based on parts by mass is high.

In Comparative Examples 2 and 3, the saturation magnetic flux density Bs is low because the total content of Fe and Co based on parts by mass is low.

In Comparative Example 4, the coercive force Hc is high because the total content of Fe and Co based on parts by mass is high.

In Comparative Examples 5, 6, 8, 9, and 24, the saturation magnetic flux density Bs is low because any of the P, B, C, or Si content based on parts by mass is high.

In Comparative Example 7, the saturation magnetic flux density Bs is low and the coercive force Hc is high because the C content based on parts by mass is high.

In Comparative Example 8, the saturation magnetic flux density Bs is low because the C content based on parts by mass is high. The C content based on parts by mass is low as compared to Comparative Example 7. Thus, the volume percentage Va of the amorphous phase is 70% or higher and the coercive force Hc is low.

In Comparative Example 9, the saturation magnetic flux density Bs is low because the Si content based on parts by mass is high.

In Comparative Examples 10 and 11, the saturation magnetic flux density Bs is low and the coercive force Hc is high because the Ni content is high.

In Comparative Examples 12, 13, and 15, the saturation magnetic flux density Bs is low because the Cr content is high.

In Comparative Example 14, the saturation magnetic flux density Bs is low and the coercive force Hc is high because the Cr content is high and the total content of P and Cr based on parts by mass is high.

In Comparative Examples 16 to 18, the multiplication product of the parts by mass of Ni and Cr is small, and the corrosion potential E_{corr} as an indicator for corrosion resistance is low. The corrosion current density i_{corr} is high.

In Comparative Examples 19 and 20, the total content of Fe, Co, and Ni based on parts by mass is high, and the coercive force Hc is high.

In Comparative Examples 21 and 22, the Ni content is low, the total content based on parts by mass of Fe, Co, and Ni is low, and the saturation magnetic flux density Bs is low.

In Comparative Example 23, the difference obtained by subtracting the multiplication product of the parts by mass of Ni×0.5 from the total content of Fe and Co is small, and the saturation magnetic flux density Bs is low.

In Comparative Example 24, the saturation magnetic flux density Bs is low because the C content based on parts by mass is high. The C content based on parts by mass is low as compared to Comparative Example 7. The Fe content based on parts by mass is low and the B content based on parts by mass is high as compared to Comparative Example 8. Thus, the volume percentage Va of the amorphous phase is 100%, and the coercive force Hc is low.

In Comparative Example 25, the saturation magnetic flux density Bs is low because the Nb content is high.

In Comparative Example 26, the corrosion potential E_{corr} as an indicator for corrosion resistance is low due to the absence of Cr.

In Comparative Example 27, the coercive force Hc is high because the Co content is high.

In Comparative Example 28, the coercive force Hc is high due to the absence of B.

In Comparative Example 29, the corrosion potential E_{corr} as an indicator for corrosion resistance is low because the multiplication product of the parts by mass of Ni and Cr is small.

The chemical composition of the alloy particles in Comparative Example 30 is the same as that in Example 30, but the composition has a low amorphous forming ability. The water pressure (one of the atomization operating conditions) was set to 0.5 times (40 MPa) that in Example 30, so that the volume percentage of the amorphous phase is low, and the coercive force Hc is high.

In Comparative Example 31, an alloy thin strip was produced by single roll liquid quenching. The alloy thin strip has the same composition as the product produced in Example 5. The same raw materials as those used in Example 5 were placed in a quartz crucible, and heated to 1400° C. in argon gas atmosphere at 1.0 atm by high-frequency induction heating. The raw materials were kept at 1400° C. for 10 minutes to prepare molten metal. The molten metal was discharged at a pressure of 0.015 MPa from a slit nozzle attached to a lower part of a quarts nozzle to a surface of a cooling copper roll. The cooling copper roll rotates at a circumferential speed of 25 m/s. The molten metal was quenched and solidified, whereby a thin strip having an average width of 10 mm and an average thickness of 24 μm was obtained.

Measurement of Corrosion Potential E_{corr} and Corrosion Current Density i_{corr} of Alloy Thin Strip

The corrosion potential (natural potential) E_{corr} and corrosion current density i_{corr} of the alloy thin strips were measured by an electrochemical measurement system (HZ-5000 available from Hokuto Denko Corporation). RE-2 and CE-2 available from EC Frontier Co., Ltd. were used as a reference electrode and a counter electrode, respectively. The alloy thin strip having a width of 10 mm and a length of 60 mm was immersed at one end up to 20 mm in a 3% by mass NaCl aqueous solution. The natural potential E_{corr} was measured with the alloy thin strip as a working electrode. Subsequently, voltage was applied to the working electrode from natural potential to +300 mV to obtain an anodic polarization curve. The scan speed was set to 2 mV/s, and the sampling interval was set to 2 s. Corrosion current determined from the anodic polarization curve was divided by the surface area (4.0 cm²) of the alloy thin strip to determine the corrosion current density i_{corr}. The corrosion current density i_{corr} was defined as the current density at a potential corresponding to the corrosion potential plus 100 mV. The corrosion potential was used as an indicator for corrosion resistance.

Table 4 shows Va, Bs, Hc, E_{corr}, and i_{corr} of the alloy thin strip of Comparative Example 31.

TABLE 4

| | | | | | | | | | | | | | Total |
|---|---|---|---|---|---|---|---|---|---|---|---|---|---|
| | | | | | | | | | | | | | content |
| | | | | | | | | | | | | | of Fe |
| | | | | | | | | | | | | | and Co |
| | Chemical composition [parts by mass] | | | | | | | | | | | | [parts |
| | Fe | P | B | C | Si | Ni | Cr | Co | Mo | W | Zr | Nb | by mass] |
| Ex - | 87.2 | 3.0 | 1.1 | 0.7 | 1.0 | 6.0 | 1.0 | 0.0 | 0.0 | 0.0 | 0.0 | 0.0 | 87.2 |
| ample 5 | | | | | | | | | | | | | |
| Com- | 87.2 | 3.0 | 1.1 | 0.7 | 1.0 | 6.0 | 1.0 | 0.0 | 0.0 | 0.0 | 0.0 | 0.0 | 87.2 |
| parative | | | | | | | | | | | | | |
| Ex- | | | | | | | | | | | | | |
| ample 31 | | | | | | | | | | | | | |

| | | | Difference | | | | | | | | | |
|---|---|---|---|---|---|---|---|---|---|---|---|---|
| | | | obtained by | | | | | | | | | |
| | | | subtracting | | | | | | | | | |
| | | | the multi- | | | | | | | | | |
| | | | plication | | | | | | | | | |
| | | | product of | | | | | | | | | |
| | | | parts by | | | | | | | | | |
| | | Total | mass of | | | | | | | | | |
| | | content | Ni × 0.5 | | | | | | | | | |
| | | of Fe, | from the | | | | | | | | | |
| | | Co, Ni | total parts | | | | | | | | | |
| | | (when | by mass of | | | | | | | | | |
| | | the Ni | Fe and Co | | Multi- | | | | | | | |
| | | content | (when the | Total | plication | Total | | | | | | |
| | Total | is 7.4 | Ni content | content | product | content | | | | | | |
| | content | parts by | is higher | of Mo, | of the | of of P | Volume | Saturation | | Corrosion | | |
| | of Fe, | mass or | than 7.4 | W, Zr, | parts by | and Cr | ratio of | magnetic | Corrosion | current | | Coercive |
| | Co, and | less) | parts by | and Nb | mass of | [parts | amorphous | flux | potential | density | | force |
| | Ni [parts | [parts by | mass) [parts | [parts | Ni and | by | phase | denisty | E_{corr} | i_{corr} | D50 | Hc |
| | by mass] | mass] | by mass] | by mass] | Cr | mass] | Va [%] | Bs [J] | [mV] | [A/m²] | [μm] | [A/m] |
| Ex- | 93.2 | 93.2 | — | 0.0 | 6.0 | 4.0 | 87 | 1.53 | -492 | 2.3 | 18 | 884 |
| ample 5 | | | | | | | | | | | | |
| Com- | 93.2 | 93.2 | — | 0.0 | 6.0 | 4.0 | 100 | 1.49 | -611 | 0.1 | — | 28 |
| parative | | | | | | | | | | | | |
| Ex- | | | | | | | | | | | | |
| ample 31 | | | | | | | | | | | | |

Table 5 shows the results of AES performed on the alloy particles of Example 5 and Comparative Example 26 and on the alloy thin strip of Comparative Example 31.

TABLE 5

| | | | Depth D from the | |
|---|---|---|---|---|
| | First | Second | surface where Ni | Corrosion |
| | average | average | concentration is | potential |
| | Ni concen- | Ni concen- | (N1 + N2) × 0.5 | Ecorr |
| | trataion N1 | tration N2 | (nm) | [mV] |
| Example 5 | 7.2 | 4.9 | 1.3 | −492 |
| Comparative | 6.6 | 6.1 | 0.8 | −629 |
| Example 26 | | | | |
| Comparative | 0.0 | 7.1 | 1.3 | −611 |
| Example 31 | | | | |

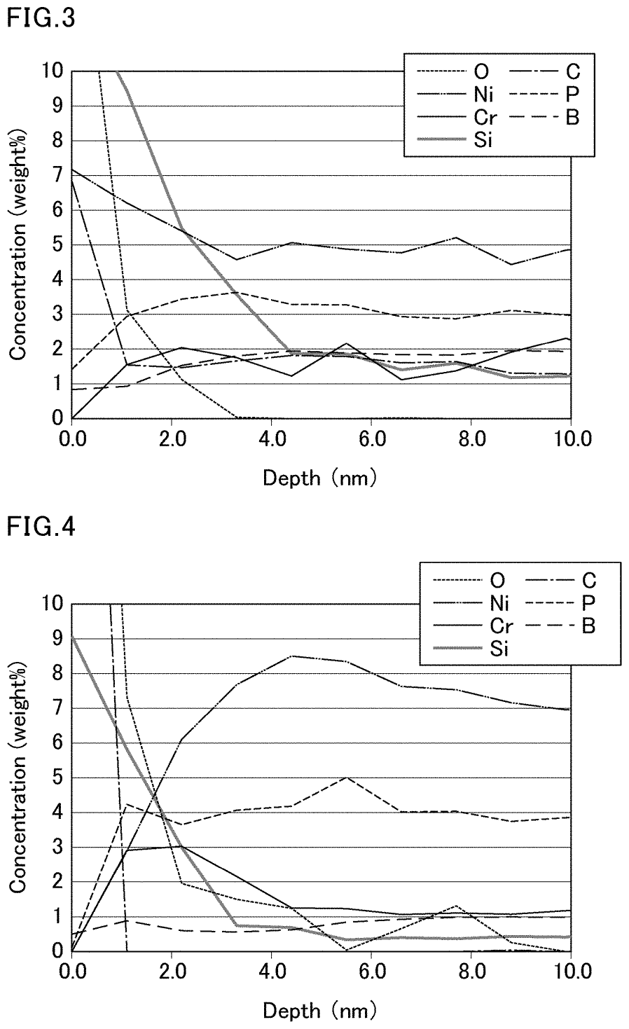

FIG. 3 and FIG. 4 show AES data of Example 5 and Comparative Example 31.

In Example 5, an inequality N1>N2 is satisfied, where N1 is the Ni concentration at a depth of 0 nm from the alloy particle surface, and N2 is the average Ni concentration in the range from a depth of 10 nm to 100 nm from the alloy particle surface; and the average distance D where the Ni concentration is (N1+N2)×0.5 (a value obtained by multiplying the sum of N1 and N2 by 0.5) as measured from the alloy particle surface is 1.3 nm or more. Thus, the corrosion potential E_{corr} as an indicator for corrosion resistance is high.

In Comparative Example 26, an inequality N1>N2 is satisfied, where N1 is the Ni concentration at a depth of 0 nm from the alloy particle surface and N2 is the average Ni concentration in the range from a depth of 10 nm to 100 nm from the alloy particle surface; but the average distance D where the Ni concentration is (N1+N2)×0.5 (a value obtained by multiplying the sum of N1 and N2 by 0.5) as measured from the alloy particle surface is less than 1.3 nm. Thus, the corrosion potential E_{corr} as an indicator for corrosion resistance is low.

In Comparative Example 31, an inequality N1<N2 is satisfied, where N1 is the Ni concentration at a depth of 0 nm from an alloy thin strip surface, and N2 is an average Ni concentration in the range from a depth of 10 nm 100 nm from the alloy thin strip surface. Thus, the corrosion potential E_{corr} as an indicator for corrosion resistance is low.

Preferred embodiments of the present disclosure have been described above, but the present disclosure is not limited to these examples. Addition, omission, replacement, and other changes can be made to the configuration without departing from the gist of the present disclosure. The present disclosure is not limited by the above description, but is limited by the scope of the claims.

What is claimed is:

1. An alloy particle comprising:
Fe, B, Ni, and Cr, and optionally Mo, W, Zr, Nb, Co, P, C, and Si,
when a total content of Fe, Co, B, Ni, P, C, Si, Nb, Cr, Mo, W, and Zr is taken as 100 parts by mass, the following holds true:
total content of Fe and Co: from 82.2 parts by mass to 96.5 parts by mass,
Co: from 0 parts by mass to 30.0 parts by mass,
P: from 0 parts by mass to 4.5 parts by mass,
B: from more than 0 parts by mass to 5.0 parts by mass,
C: from 0 parts by mass to 3.0 parts by mass,
Si: from 0 parts by mass to 6.7 parts by mass,
Ni: from more than 0 parts by mass to 12.0 parts by mass,
Cr: from more than 0 parts by mass to 4.2 parts by mass,
total content of Mo, W, Zr, and Nb: from 0 parts by mass to 4.2 parts by mass,
total content of P and Cr: 7.4 parts by mass or less,
multiplication product of the parts by mass of Ni and Cr: 0.5 or more,
total content of Fe, Co, and Ni: 97.0 parts by mass or less,
when the Ni content is from more than 0 parts by mass to 7.4 parts by mass, a total content of Fe, Co, and Ni is 89.6 parts by mass or more; and when the Ni content is from more than 7.4 parts by mass to 12.0 parts by mass, a difference obtained by subtracting a multiplication product of the parts by mass of Ni×0.5 from the total content of Fe and Co is 78.5 parts by mass or more,
the alloy particle contains an amorphous phase, and
a volume percentage of the amorphous phase is 70% or higher.

2. An alloy particle containing an amorphous phase, comprising:
Fe, B, Ni, and Cr, and optionally Mo, W, Zr, Nb, Co, P, C, and Si,
wherein in a depth concentration profile of components of the alloy particle, an inequality N1>N2 is satisfied, where N1 is a Ni concentration at a depth of 0 nm from a surface, and N2 is an average Ni concentration in a region from a depth of 10 nm to 100 nm from the surface, and an average distance D where the Ni concentration is (N1+N2)×0.5 as measured from the surface is 1.3 nm or more.

3. A coil component, comprising:
a magnetic core containing the alloy particle according to claim 1; and
a coil.

4. A coil component, comprising:
a magnetic core containing the alloy particle according to claim 2; and
a coil.
